(19) United States
(12) Patent Application Publication
(10) Pub. No.: US 2024/0128912 A1
(43) Pub. Date: Apr. 18, 2024

(54) POWER CONVERTER, MOTOR DRIVING APPARATUS, AND AIR CONDITIONER

(71) Applicant: Mitsubishi Electric Corporation, Tokyo (JP)

(72) Inventors: Koichi ARISAWA, Tokyo (JP); Takuya SHIMOMUGI, Tokyo (JP); Takaaki TAKAHARA, Tokyo (JP); Haruka MATSUO, Tokyo (JP); Keisuke UEMURA, Tokyo (JP)

(21) Appl. No.: 18/259,430

(22) PCT Filed: Feb. 12, 2021
(86) PCT No.: PCT/JP2021/005359

§ 371 Date: Jun. 27, 2023

(51) Int. Cl. H02P 27/08; F24F 11/88

(52) U.S. Cl. CPC H02P 27/08; F24F 11/88; F24F 11/65

(57) ABSTRACT

A power converter includes: a rectifying and boosting unit that rectifies first alternating-current power supplied from a commercial power supply and boosts a voltage of the first alternating-current power; a capacitor connected to an output end of the rectifying and boosting unit; an inverter to convert power output from the rectifying and boosting unit and the capacitor into second alternating-current power, and output the second alternating-current power to a device; and a control unit that reduces a current flowing through the capacitor by controlling the rectifying and boosting unit and by controlling the inverter such that the inverter outputs, to the device, the second alternating-current power containing a ripple dependent on a ripple of power flowing from the rectifying and boosting unit into the capacitor. The control unit controls operation of the power converter in accordance with an air-conditioning condition of an air conditioner.

### FIELD

The present disclosure relates to a power converter that converts alternating-current power into desired power, a motor driving apparatus, and an air conditioner.

### BACKGROUND

Some known power converters convert alternating-current power supplied from alternating-current power supplies, into desired alternating-current power, and supply the alternating-current power to loads such as an air conditioner. For example, Patent Literature 1 discloses a power converter that is a control device of an air conditioner. Such a power converter includes a diode stack as a rectifying unit for rectifying alternating-current power supplied from an alternating-current power supply, a smoothing capacitor for smoothing power, and an inverter having a plurality of switching elements for converting the thus smoothed power into desired alternating-current power and outputting the same to a compressor motor that is a load.

### CITATION LIST

### Patent Literature

Patent Literature 1: Japanese Patent Application Laid-open No. H7-71805

### SUMMARY OF INVENTION

### Problem to be Solved by the Invention

For the above conventional power converter, unfortunately, a large current flows through the smoothing capacitor, which causes a problem of accelerating aging of the smoothing capacitor. A possible method of addressing such a problem includes increasing the capacitance of the smoothing capacitor to reduce a ripple change in a capacitor voltage, or using a smoothing capacitor having high tolerance to deterioration due to ripples, which unfortunately increases the cost of the capacitor component and increases the size of the device.

The present disclosure has been made in view of the above, and an object thereof is to provide a power converter that can avoid an increase in size of the device as well as preventing or reducing deterioration of a smoothing capacitor.

### Means to Solve the Problem

To solve the above problem and achieve the object, the present disclosure provides a power converter to be installed in an air conditioner, the power converter comprising: a rectifying and boosting unit to rectify first alternating-current power supplied from a commercial power supply and boost a voltage of the first alternating-current power; a capacitor connected to an output end of the rectifying and boosting unit; an inverter connected across the capacitor, to convert power output from the rectifying and boosting unit and the capacitor, into second alternating-current power, and output the second alternating-current power to a device equipped with a motor; and a control unit to reduce a current flowing through the capacitor by controlling an operation of the rectifying and boosting unit and by controlling an operation of the inverter such that the inverter outputs, to the device, the second alternating-current power containing a ripple dependent on a ripple of power flowing from the rectifying and boosting unit into the capacitor, wherein the control unit controls operation of the power converter in accordance with an air-conditioning condition of the air conditioner.

### Effects of the Invention

The power converter according to the present disclosure has an effect of avoiding the increase in size of the device as well as preventing or reducing deterioration of the smoothing capacitor.

### BRIEF DESCRIPTION OF DRAWINGS

FIG. 1 is a first diagram illustrating an example of a configuration of a power converter according to a first embodiment.

FIG. 2 is a second diagram illustrating an example of the configuration of the power converter according to the first embodiment.

FIG. 3 is a third diagram illustrating an example of the configuration of the power converter according to the first embodiment.

FIG. 4 is a set of graphs illustrating an a comparative example of currents and a capacitor voltage of a capacitor in a smoothing unit when the smoothing unit smooths the current output from a boosting unit to provide the constant current flowing through an inverter.

FIG. 5 is a set of graphs illustrating an example of the currents and the capacitor voltage of the capacitor in the smoothing unit when a control unit of the power converter according to the first embodiment controls an operation of the inverter to reduce the current flowing through the smoothing unit.

FIG. 6 is a first table illustrating operation modes and contents of the operation modes of the power converter according to the first embodiment.

FIG. 7 is a second table illustrating operation modes and contents of the operation modes of the power converter according to the first embodiment.

FIG. 8 is a first table illustrating examples of a hardware configuration of an air conditioner equipped with the power converter according to the first embodiment.

FIG. 9 is a second table illustrating examples of the hardware configuration of the air conditioner equipped with the power converter according to the first embodiment.

FIG. 10 is a table illustrating relationships between air-conditioning conditions and the operation modes in a case where the air conditioner equipped with the power converter according to the first embodiment has a configuration 101.

FIG. 11 is a table illustrating the relationships between the air-conditioning conditions and the operation modes in a case where the air conditioner equipped with the power converter according to the first embodiment has a configuration 102.

FIG. 12 is a table illustrating the relationships between the air-conditioning conditions and the operation modes in a case where the air conditioner equipped with the power converter according to the first embodiment has a configuration 103.

FIG. 13 is a table illustrating the relationships between the air-conditioning conditions and the operation modes in a case where the air conditioner equipped with the power converter according to the first embodiment has a configuration 104.

FIG. 14 is a table illustrating the relationships between the air-conditioning conditions and the operation modes in a case where the air conditioner equipped with the power converter according to the first embodiment has a configuration 105.

FIG. 15 is a table illustrating the relationships between the air-conditioning conditions and the operation modes in a case where the air conditioner equipped with the power converter according to the first embodiment has a configuration 106.

FIG. 16 is a table illustrating the relationships between the air-conditioning conditions and the operation modes in a case where the air conditioner equipped with the power converter according to the first embodiment has a configuration 107.

FIG. 17 is a table illustrating the relationships between the air-conditioning conditions and the operation modes in a case where the air conditioner equipped with the power converter according to the first embodiment has a configuration 108.

FIG. 18 is a table illustrating the relationships between the air-conditioning conditions and the operation modes in a case where the air conditioner equipped with the power converter according to the first embodiment has a configuration 109.

FIG. 19 is a table illustrating the relationships between the air-conditioning conditions and the operation modes in a case where the air conditioner equipped with the power converter according to the first embodiment has a configuration 110.

FIG. 20 is a table illustrating the relationships between the air-conditioning conditions and the operation modes in a case where the air conditioner equipped with the power converter according to the first embodiment has a configuration 111.

FIG. 21 is a table illustrating the relationships between the air-conditioning conditions and the operation modes in a case where the air conditioner equipped with the power converter according to the first embodiment has a configuration 112.

FIG. 22 is a table illustrating the relationships between the air-conditioning conditions and the operation modes in a case where the air conditioner equipped with the power converter according to the first embodiment has a configuration 113.

FIG. 23 is a table illustrating the relationships between the air-conditioning conditions and the operation modes in a case where the air conditioner equipped with the power converter according to the first embodiment has a configuration 114.

FIG. 24 is a table illustrating the relationships between the air-conditioning conditions and the operation modes in a case where the air conditioner equipped with the power converter according to the first embodiment has a configuration 115.

FIG. 25 is a table illustrating the relationships between the air-conditioning conditions and the operation modes in a case where the air conditioner equipped with the power converter according to the first embodiment has a configuration 116.

FIG. 26 is a table illustrating the relationships between the air-conditioning conditions and the operation modes in a case where the air conditioner equipped with the power converter according to the first embodiment has a configuration 117.

FIG. 27 is a table illustrating the relationships between the air-conditioning conditions and the operation modes in a case where the air conditioner equipped with the power converter according to the first embodiment has a configuration 118.

FIG. 28 is a table illustrating the relationships between the air-conditioning conditions and the operation modes in a case where the air conditioner equipped with the power converter according to the first embodiment has a configuration 119.

FIG. 29 is a table illustrating the relationships between the air-conditioning conditions and the operation modes in a case where the air conditioner equipped with the power converter according to the first embodiment has a configuration 120.

FIG. 30 is a table illustrating the relationships between the air-conditioning conditions and the operation modes in a case where the air conditioner equipped with the power converter according to the first embodiment has a configuration 121.

FIG. 31 is a table illustrating the relationships between the air-conditioning conditions and the operation modes in a case where the air conditioner equipped with the power converter according to the first embodiment has a configuration 122.

FIG. 32 is a table illustrating the relationships between the air-conditioning conditions and the operation modes in a case where the air conditioner equipped with the power converter according to the first embodiment has a configuration 123.

FIG. 33 is a table illustrating the relationships between the air-conditioning conditions and the operation modes in a case where the air conditioner equipped with the power converter according to the first embodiment has a configuration 124.

FIG. 34 is a graph illustrating an example of a change in power consumption during cooling operation of the air conditioner equipped with the power converter according to the first embodiment.

FIG. 35 is a graph illustrating an example of a change in power consumption during heating operation of the air conditioner equipped with the power converter according to the first embodiment.

FIG. 36 is a flowchart illustrating an operation of the control unit included in the power converter according to the first embodiment.

FIG. 37 is a diagram illustrating an example of a hardware configuration that implements the control unit included in the power converter according to the first embodiment.

FIG. 38 is a diagram illustrating an example of a configuration of a refrigeration cycle applied apparatus according to a second embodiment.

### DESCRIPTION OF EMBODIMENTS

A power converter, a motor driving apparatus, and an air conditioner according to embodiments of the present disclosure will be hereinafter described in detail with reference to the drawings.

### First Embodiment

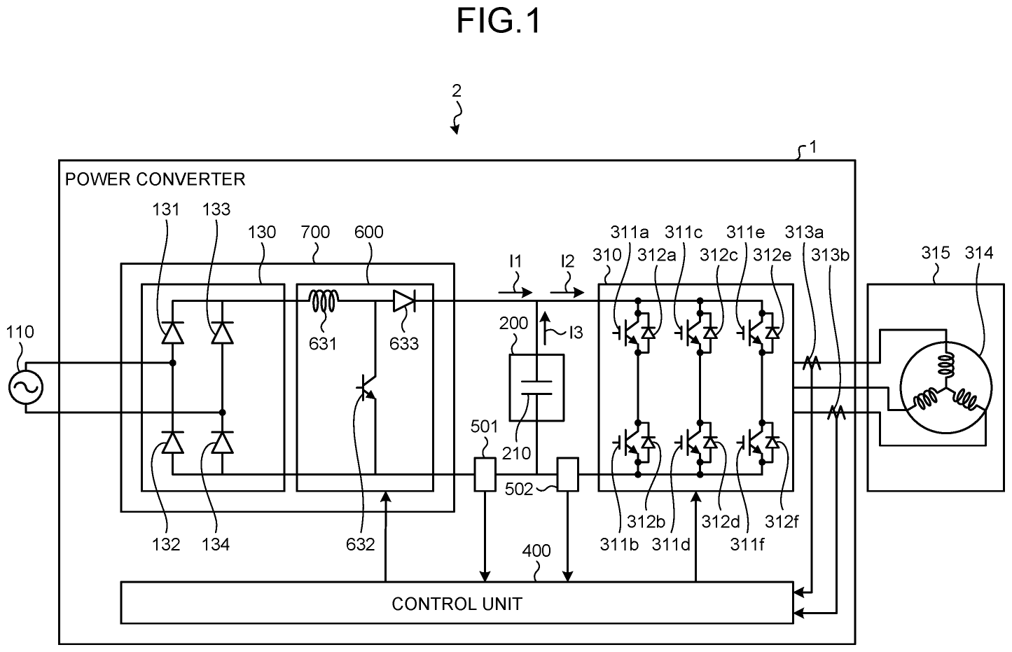

FIG. 1 is a first diagram illustrating an example of a configuration of a power converter 1 according to a first embodiment. The power converter 1 is connected to a commercial power supply 110 and a compressor 315. The power converter 1 converts first alternating-current power of a power supply voltage Vs supplied from the commercial power supply 110, into second alternating-current power having desired amplitude and phase, and supplies the second alternating-current power to the compressor 315. The power converter 1 includes a rectifying unit 130, a boosting unit 600, a current detection unit 501, a smoothing unit 200, a current detection unit 502, an inverter 310, current detection units 313a and 313b, and a control unit 400. Note that in the power converter 1, the rectifying unit 130 and the boosting unit 600 make up a rectifying and boosting unit 700. Also, the power converter 1 and a motor 314 of the compressor 315 make up a motor driving apparatus 2.

The rectifying unit 130 includes a bridge circuit including rectifier elements 131 to 134, and rectifies and outputs the first alternating-current power of the power supply voltage Vs supplied from the commercial power supply 110. The rectifying unit 130 performs full-wave rectification.

The boosting unit 600 includes a reactor 631, a switching element 632, and a diode 633. The boosting unit 600 turns on and off the switching element 632 under the control of the control unit 400, boosts the power output from the rectifying unit 130, and outputs the boosted power to the smoothing unit 200. In the present embodiment, the boosting unit 600 is controlled by the control unit 400 such that the boosting unit 600 performs full pulse amplitude modulation (PAM) that allows the switching element 632 to continuously perform a switching operation. The boosting unit 600 of the power converter 1 performs power factor correction control on the commercial power supply 110, and provides a higher capacitor voltage Vdc of a capacitor 210 of the smoothing unit 200 than the power supply voltage Vs.

The rectifying and boosting unit 700, which is made up of the rectifying unit 130 and the boosting unit 600, rectifies the first alternating-current power supplied from the commercial power supply 110 and boosts the voltage of the first alternating-current power supplied from the commercial power supply 110. In the present embodiment, the rectifying unit 130 and the boosting unit 600 are connected in series with each other in the rectifying and boosting unit 700.

The current detection unit 501 detects a current value of the power boosted by the boosting unit 600, and outputs the detected current value to the control unit 400.

The smoothing unit 200 is connected to an output end of the boosting unit 600. The smoothing unit 200 includes the capacitor 210 as a smoothing element, and smooths the power boosted by the boosting unit 600. The capacitor 210 is, for example, an electrolytic capacitor, a film capacitor, etc. The capacitor 210 has such capacitance as to smooth the power rectified by the rectifying unit 130. The voltage generated in the capacitor 210 by the smoothing does not have a full-wave rectified waveform of the commercial power supply 110 but has a waveform having a voltage ripple superimposed on a direct-current component, the voltage ripple corresponding to the frequency of the commercial power supply 110. The voltage of the waveform having the voltage ripple superposed on the direct-current component does not ripple much. The frequency of the voltage ripple is mainly composed of a component that is twice the frequency of the power supply voltage Vs in the case of the commercial power supply 110 having a single phase, or a component that is six times the frequency of the power supply voltage Vs in the case of the commercial power supply 110 having three phases. In a case where the power input from the commercial power supply 110 and the power output from the inverter 310 are the same, the amplitude of the voltage ripple is determined by the capacitance of the capacitor 210. For example, the ripple occurs to such an extent that the maximum value of the voltage ripple generated in the capacitor 210 is less than twice the minimum value thereof.

The current detection unit 502 detects a current value of the current flowing through the inverter 310, and outputs the detected current value to the control unit 400.

The inverter 310 is connected across the smoothing unit 200, that is, across the capacitor 210. The inverter 310 includes switching elements 311a to 311f and freewheeling diodes 312a to 312f. The inverter 310 turns on and off the switching elements 311a to 311f under the control of the control unit 400, converts the power output from the rectifying and boosting unit 700 and the smoothing unit 200, into the second alternating-current power having desired amplitude and phase, and outputs the second alternating-current power to the compressor 315 that is a device equipped with the motor 314. The current detection units 313a and 313b each detect a current value of one phase among three phase currents output from the inverter 310, and output the detected current value to the control unit 400. Note that by acquiring current values of two phases among the current values of three phases output from the inverter 310, the control unit 400 can calculate a current value of the remaining one phase output from the inverter 310. The compressor 315 is a load including the motor 314 for driving the compressor. The motor 314 rotates in accordance with the amplitude and phase of the second alternating-current power supplied from the inverter 310, and performs a compression operation. For example, in a case where the compressor 315 is a hermetic compressor used in an air conditioner or the like, a load torque of the compressor 315 can be regarded as a constant torque load in many cases. FIG. 1 illustrates the motor 314 having windings in Y-connection by way of example, and the present disclosure is not limited thereto. The motor winding of the motor 314 may be in delta “A” connection or may be in a mode switchable between Y connection and A connection.

Note that, in the power converter 1, the configuration and placement of each unit illustrated in FIG. 1 are an example and not limited to the example illustrated in FIG. 1. For example, the rectifying and boosting unit 700 may include four switching elements to turn on and off the four switching elements under the control of the control unit 400, rectify and boost the first alternating-current power output from commercial power supply 110, and output the boosted power to smoothing unit 200. Alternatively, the rectifying and boosting unit 700 may have a configuration including the boosting unit and the rectifying unit 130 that are connected in parallel to each other.

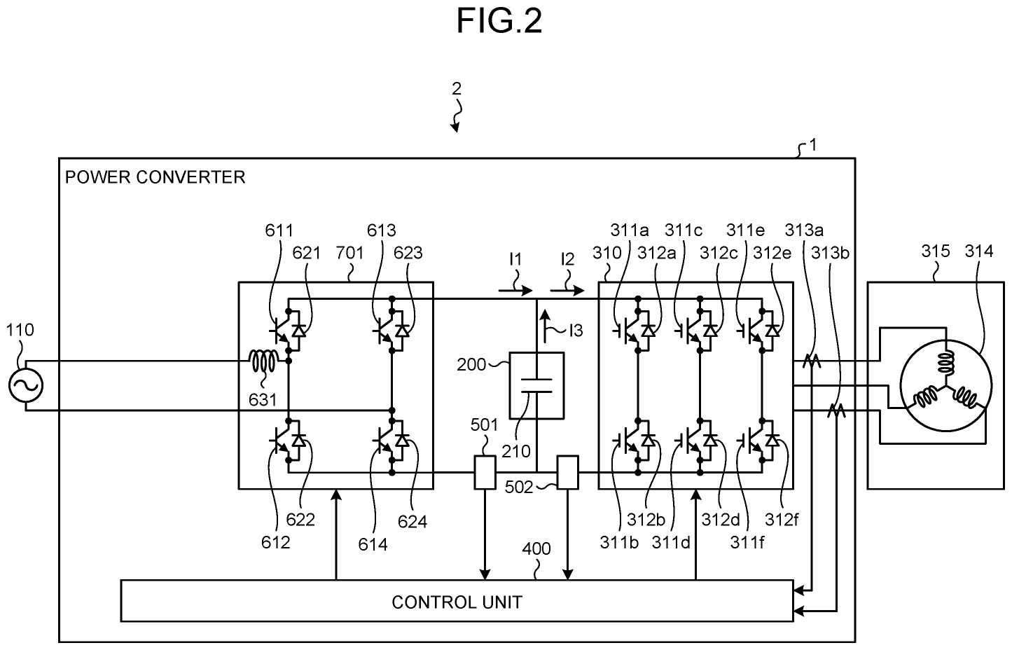

FIG. 2 is a second diagram illustrating an example of the configuration of the power converter 1 according to the first embodiment. The power converter 1 is the power converter 1 illustrated in FIG. 1 with the rectifying and boosting unit 700 replaced with a rectifying and boosting unit 701. Note that the power converter 1 and the motor 314 of the compressor 315 make up the motor driving apparatus 2. The rectifying and boosting unit 701 includes the reactor 631, switching elements 611 to 614, and rectifier elements 621 to 624 each connected in parallel to a corresponding one of the switching elements 611 to 614. Also, the reactor 631 of the present configuration is inserted only in one of connecting wires interconnecting the commercial power supply 110 and the rectifying and boosting unit 701, but may be inserted in both of the connecting wires. The rectifying and boosting unit 701 turns on and off the switching elements 611 to 614 under the control of the control unit 400, rectifies and boosts the first alternating-current power output from the commercial power supply 110, and outputs the boosted power to the smoothing unit 200. The rectifying and boosting unit 701 is controlled by the control unit 400 such that the rectifying and boosting unit 701 performs full PAM that allows the switching elements 611 to 614 to continuously perform the switching operation.

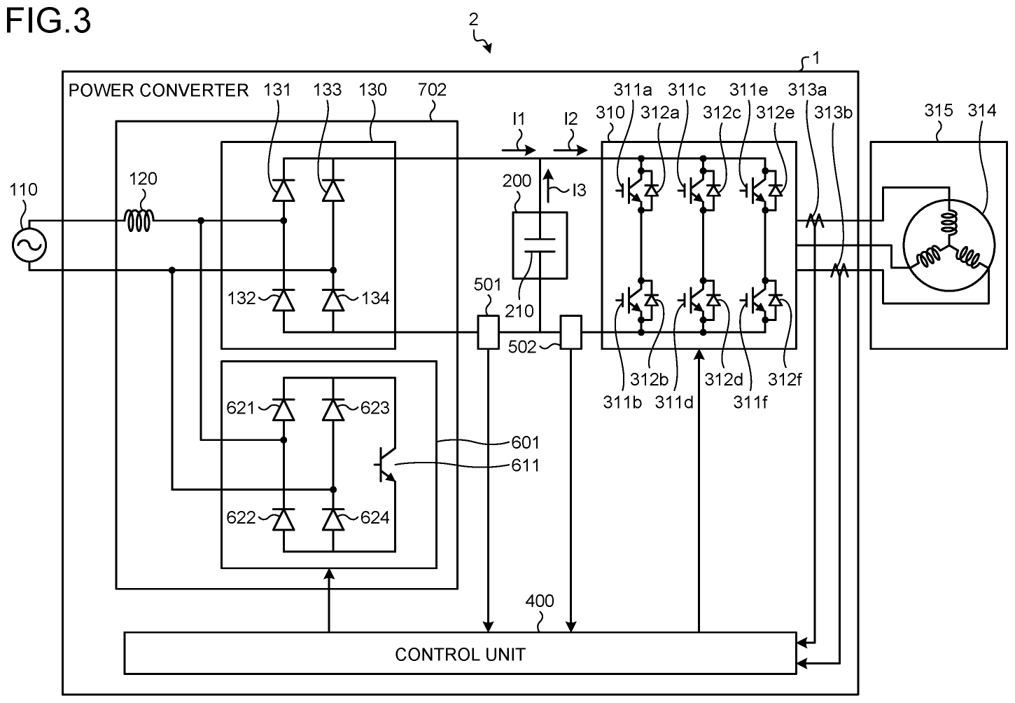

FIG. 3 is a third diagram illustrating an example of the configuration of the power converter 1 according to the first embodiment. The power converter 1 is the power converter 1 illustrated in FIG. 1 with the rectifying and boosting unit 700 replaced with a rectifying and boosting unit 702. Note that the power converter 1 and the motor 314 of the compressor 315 make up the motor driving apparatus 2. The rectifying and boosting unit 702 includes a reactor 120, the rectifying unit 130, and a boosting unit 601. In the power converter 1 illustrated in FIG. 1, the boosting unit 600 is a subsequent stage connected to the rectifying unit 130. That is, the boosting unit 600 in FIG. 1 is connected in series with the rectifying unit 130 inside the power converter 1, whereas the boosting unit 601 is connected in parallel with the rectifying unit 130 inside the power converter 1. The boosting unit 601 includes the rectifier elements 621 to 624 and the switching element 611. The boosting unit 601 turns on and off the switching element 611 under the control of the control unit 400, boosts the first alternating-current power output from the commercial power supply 110, and outputs the boosted power to the rectifying unit 130. The boosting unit 601 of the rectifying and boosting unit 702 is controlled by the control unit 400 such that the boosting unit 601 performs simple switching that allows the switching element 611 to perform the switching operation once or a plurality of times in a half cycle of the frequency of the first alternating-current power supplied from the commercial power supply 110.

Unless otherwise specified, the power converter 1 illustrated in FIG. 1 will be hereinafter described by way of example. Also, in the following description, the current detection units 501, 502, 313a, and 313b may be collectively referred to as detection units. Moreover, the current values detected by the current detection units 501, 502, 313a, and 313b may be referred to as detected values. The power converter 1 may include a detection unit other than the above-described detection units. Although not illustrated in FIG. 1, the power converter 1 typically includes a detection unit that detects the capacitor voltage Vdc. The power converter 1 may include a detection unit that detects a voltage, a current, etc. of the first alternating-current power supplied from the commercial power supply 110.

The control unit 400 acquires, from the current detection unit 501, the current value of the power boosted by the boosting unit 600, acquires, from the current detection unit 502, the current value of the current flowing through the inverter 310, and acquires, from the current detection units 313a and 313b, the current values of the second alternating-current power having the desired amplitude and phase after conversion by the inverter 310. The control unit 400 uses the detected values detected by the detection units to control the operation of the boosting unit 600 in the rectifying and boosting unit 700, specifically, control on/off of the switching element 632 of the boosting unit 600. In addition, the control unit 400 uses the detected values detected by the detection units to control the operation of the inverter 310, specifically, control on/off of the switching elements 311a to 311f included in the inverter 310. In the present embodiment, the control unit 400 controls the operation of the rectifying and boosting unit 700. The control unit 400 controls the operation of the rectifying and boosting unit 700 to perform power factor correction control of the first alternating-current power supplied from the commercial power supply 110 and perform average voltage control of the capacitor 210 in the smoothing unit 200. In addition, the control unit 400 controls the operation of the inverter 310 such that the inverter 310 outputs, to the compressor 315 as the load, the second alternating-current power containing a ripple dependent on a ripple of the power flowing from the rectifying and boosting unit 700 into the capacitor 210 of the smoothing unit 200. The ripple dependent on the ripple of the power flowing into the capacitor 210 of the smoothing unit 200 is, for example, a ripple that varies depending on, for example, the frequency of the ripple of the power flowing into the capacitor 210 of the smoothing unit 200. As a result, the control unit 400 reduces the current flowing through the capacitor 210 of the smoothing unit 200. Note that the control unit 400 need not use all the detected values acquired from the detection units, and may perform control using some of the detected values.

Next, the operation of the control unit 400 included in the power converter 1 will be described. The description of the present embodiment will be hereinbelow made assuming that, in the power converter 1, a load generated by the inverter 310 and the compressor 315 can be regarded as a constant load, and in terms of the current output from the smoothing unit 200, a constant current load is connected to the smoothing unit 200. As illustrated in FIG. 1, the current flowing from the boosting unit 600 is defined as a current I1, the current flowing through the inverter 310 is defined as a current I2, and the current flowing from the smoothing unit 200 is defined as a current I3. The current I2 is a combination of the current I1 and the current I3. The current I3 can be expressed as a difference between the current I2 and the current I1, that is, the current I2−the current I1. The current I3 takes a positive direction that is a direction of discharge of the smoothing unit 200, and a negative direction that is a direction of charge of the smoothing unit 200. That is, the current can flow in and out of the smoothing unit 200.

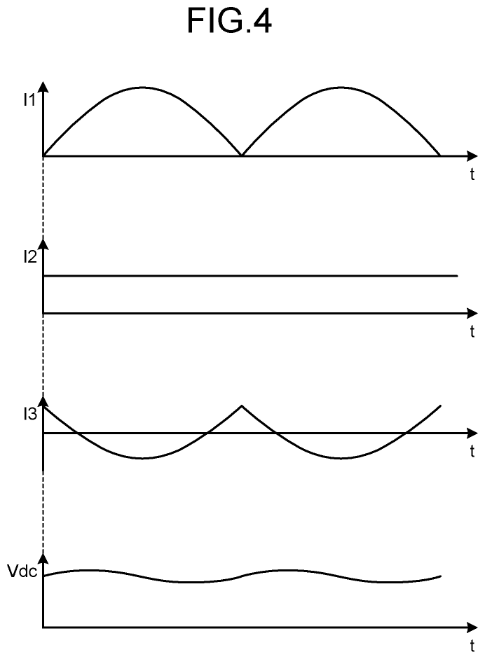

FIG. 4 is a set of graphs illustrating a comparative example of the currents I1 to I3 and the capacitor voltage Vdc of the capacitor 210 in the smoothing unit 200 when the smoothing unit 200 smooths the current output from the boosting unit 600 to provide the constant current I2 flowing through the inverter 310. The graph illustrates, in order from the top, the current I1, the current I2, the current I3, and the capacitor voltage Vdc of the capacitor 210 generated in accordance with the current I3. Vertical axes of the currents I1, I2, and I3 represent a current value, and a vertical axis of the capacitor voltage Vdc represents a voltage value. Horizontal axes all represent time “t”. Note that a carrier component of the inverter 310 is superimposed on the currents I2 and I3 in practice, but is omitted herein. Such omission also applies to the subsequent drawings. As illustrated in FIG. 4, in the power converter 1, if the current I1 flowing from the boosting unit 600 is sufficiently smoothed by the smoothing unit 200, the current I2 flowing through the inverter 310 has a constant current value. Unfortunately, the large current I3 flows through the capacitor 210 of the smoothing unit 200 and can cause deterioration. In view of this, in the present embodiment, the control unit 400 of the power converter 1 controls the current I2 flowing through the inverter 310, that is, controls the operation of the inverter 310 so as to reduce the current I3 flowing through the smoothing unit 200.

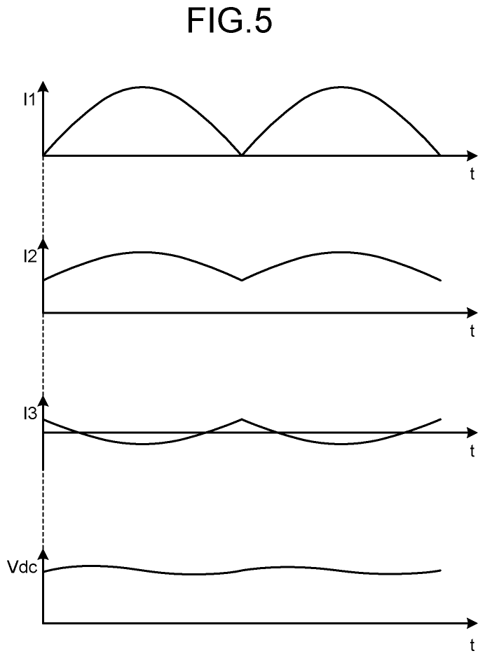

FIG. 5 is a set of graphs illustrating an example of the currents I1 to I3 and the capacitor voltage Vdc of the capacitor 210 in the smoothing unit 200 when the control unit 400 of the power converter 1 according to the first embodiment controls the operation of the inverter 310 to reduce the current I3 flowing through the smoothing unit 200. The graph illustrates, in order from the top, the current I1, the current I2, the current I3, and the capacitor voltage Vdc of the capacitor 210 generated in accordance with the current I3. Vertical axes of the currents I1, I2, and I3 represent a current value, and a vertical axis of the capacitor voltage Vdc represents a voltage value. Horizontal axes all represent time “t”. The control unit 400 of the power converter 1 controls the operation of the inverter 310 such that the current I2 as illustrated in FIG. 5 flows through the inverter 310, thereby reducing a frequency component of the current flowing from the boosting unit 600 to the smoothing unit 200 and reducing the current I3 flowing through the smoothing unit 200, as compared with the example of FIG. 4. Specifically, the control unit 400 controls the operation of the inverter 310 such that the current I2 containing a ripple current, which has a frequency component of the current I1 as a main component, flows through the inverter 310.

The frequency component of the current I1 is determined by the frequency of the alternating current supplied from the commercial power supply 110, the configuration of the rectifying unit 130, and the switching speed of the switching element 632 in the boosting unit 600. Thus, the control unit 400 can set a predetermined amplitude and phase of the frequency component of the ripple current superimposed on the current I2. The frequency component of the ripple current superimposed on the current I2 has a waveform similar to that of the frequency component of the current I1. As setting the closer frequency component of the ripple current superimposed on the current I2 to the frequency component of the current I1, the control unit 400 can reduce the current I3 flowing through the smoothing unit 200 and reduce a ripple voltage generated in the capacitor voltage Vdc.

The control unit 400 controlling the ripple of the current flowing through the inverter 310 by controlling the operation of the inverter 310 is the same as controlling a ripple of the second alternating-current power output from the inverter 310 to the compressor 315. The control unit 400 controls the operation of the inverter 310 such that the ripple contained in the second alternating-current power output from the inverter 310 is smaller than the ripple of the power output from the rectifying and boosting unit 700. The control unit 400 controls the amplitude and phase of the ripple contained in the second alternating-current power output from the inverter 310 such that the voltage ripple of the capacitor voltage Vdc, that is, the voltage ripple generated in the capacitor 210 is smaller than the voltage ripple generated in the capacitor 210 when the second alternating-current power output from the inverter 310 does not contain the ripple dependent on the ripple of the power flowing into the capacitor 210. When the second alternating-current power output from the inverter 310 does not contain the ripple dependent on the ripple of the power flowing into the capacitor 210, the control as illustrated in FIG. 4 is performed.

Note that the alternating current supplied from the commercial power supply 110 is not particularly limited to a particular alternating current. For example, the alternating current may be a single-phase or three-phase alternating current. The control unit 400 may determine the frequency component of the ripple current superimposed on the current I2, in accordance with the first alternating-current power supplied from the commercial power supply 110. Specifically, under the control of the control unit 400, the ripple waveform of the current I2 flowing through the inverter 310 is in a shape having a direct current component added thereto. This ripple waveform has its main component that is a frequency component twice or six times the frequency of the first alternating-current power. The main component is a frequency component twice the frequency of the first alternating-current power when the first alternating-current power supplied from the commercial power supply 110 has a single phase while the main component is a frequency component six times the frequency of the first alternating-current power when the first alternating-current power supplied from the commercial power supply 110 has three phases. The ripple waveform has, for example, a shape of an absolute value of a sine wave or a shape of a sine wave. In this case, the control unit 400 may add, to the ripple waveform, a predetermined amplitude that is at least one frequency component among components that are integer multiples of the frequency of the sine wave.

Alternatively, the ripple waveform may have a shape of a rectangular wave or a shape of a triangular wave. In this case, the control unit 400 may set the amplitude and phase of the ripple waveform to predetermined values.

Using the voltage applied to the capacitor 210 or the current flowing through the capacitor 210, the control unit 400 may calculate a ripple amount of the ripple contained in the second alternating-current power output from the inverter 310. Alternatively, using the voltage or current of the first alternating-current power supplied from the commercial power supply 110, the control unit 400 may calculate the ripple amount of the ripple contained in the second alternating-current power output from the inverter 310.

Moreover, when controlling the inverter 310 such that the second alternating-current power containing a frequency component different from the frequency component of the first alternating-current power supplied from commercial power supply 110 is output from the inverter 310 to the compressor 315, the control unit 400 may allow the frequency component contained in the second alternating-current power output from the inverter 310 to the compressor 315 to be superimposed on a drive signal for turning on/off the switching element 632 in the boosting unit 600. That is, the control unit 400 controls the operation of the rectifying and boosting unit 700, specifically, the operation of the switching element 632 in the boosting unit 600 such that the rectifying and boosting unit 700 outputs power containing a variable frequency component among power ripples of the second alternating-current power output from the inverter 310 to the compressor 315, the variable frequency component being other than the frequency component twice the frequency of the first alternating-current power in the case of the single-phase first alternating-current power supplied from the commercial power supply 110, or the frequency component six times the frequency of the first alternating-current power in the case of the three-phase first alternating-current power supplied from the commercial power supply 110. The control unit 400 may control the variable frequency component, using a command value for the commercial power supply 110. Alternatively, the control unit 400 may control the variable frequency component such that the variable frequency component is not a component that is an integer multiple up to 40th order of the frequency of the first alternating-current power supplied from commercial power supply 110, or such that the variable frequency component has a prescribed value such as a desired standard value or less.

Next, a description will be made of an operation of the power converter 1 installed in a refrigeration cycle applied apparatus. For example, in a case where the power converter 1 is installed in an air conditioner that is the refrigeration cycle applied apparatus, an operation mode of the power converter 1 changes greatly depending on an operating state of the air conditioner. For example, in the presence of a large temperature difference between a user's set temperature, that is, a user's desired temperature, and a current room temperature of a room to be air conditioned by the air conditioner, the power converter 1 installed in the air conditioner has an increased load. On the other hand, in a case where the temperature difference is small between the user's desired temperature and the current room temperature, the power converter 1 installed in the air conditioner has a reduced load. Moreover, in a case where the current I3 flowing through the smoothing unit 200 is sufficiently small due to the state of operation of the air conditioner, it is conceivable that the control unit 400 need not necessarily perform the control for reducing the current I3 flowing through the smoothing unit 200 and reducing the ripple voltage generated in the capacitor voltage Vdc as described above. In view of this, the control unit 400 of the power converter 1 performs the various controls described above in accordance with a load state, i.e., an operating state of a load, and determines the operation mode. The load includes the inverter 310, the motor 314, and a device equipped with the motor 314. The device equipped with the motor 314 includes, but is not limited to, the compressor 315 described above, a fan installed in the air conditioner, and the like.

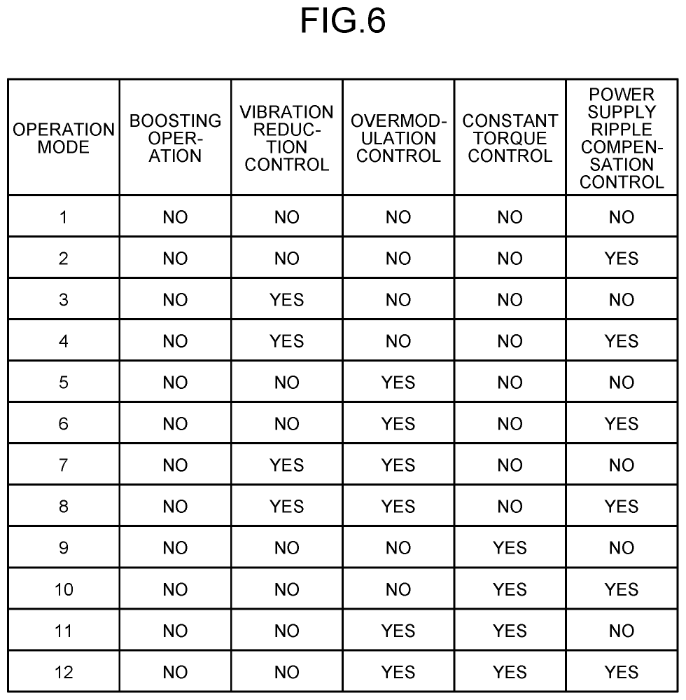

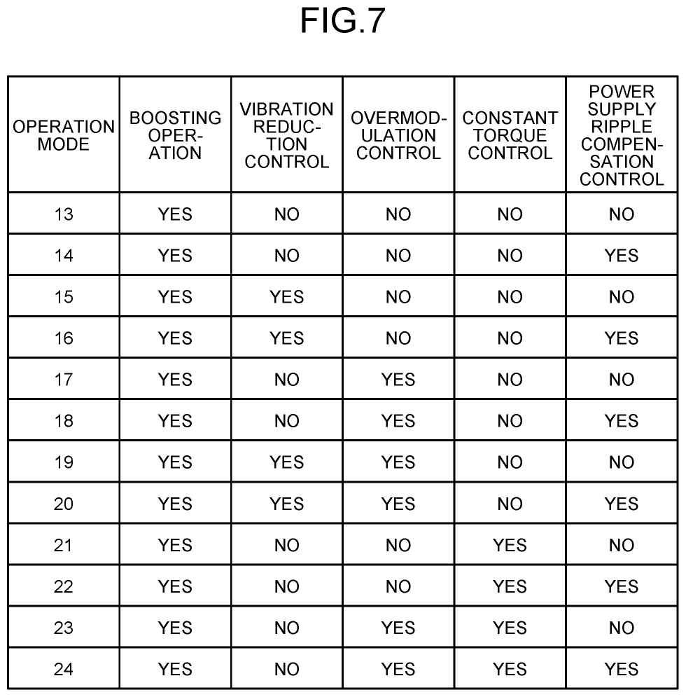

FIG. 6 is a first table illustrating operation modes and contents of the operation modes of the power converter 1 according to the first embodiment. FIG. 7 is a second table illustrating operation modes and contents of the operation modes of the power converter 1 according to the first embodiment. FIG. 6 is the table illustrating the operation modes in which the boosting operation of the boosting unit 600 in the power converter 1 is in an off state, and FIG. 7 is the table illustrating the operation modes in which the boosting operation of the boosting unit 600 in the power converter 1 is in an on state.

The boosting operation is performed by the boosting unit 600 for boosting the power supply voltage Vs supplied from the commercial power supply 110 in order to provide a driving range in which to rotate the motor 314 at high speed. Specifically, the control unit 400 controls on/off of the switching element 632 in the boosting unit 600.

Vibration reduction control reduces vibration by adjusting torque applied from the inverter 310 to load torque variation when the vibration occurs due to the load torque variation caused by a mechanical mechanism such as the compressor 315 during the one rotation of the motor 314.

Overmodulation control increases an output voltage of the inverter 310 in order to drive the motor 314 in a high speed range. The power converter 1 has a limited supply voltage as the power converter 1 uses the commercial power supply 110. For this reason, the electromotive force of the motor 314 becomes higher than the supply voltage when the motor 314 rotates at high speed, which results in difficulty of the rotation. To address this, the power converter 1 slightly raises a fundamental wave component of the output voltage by distorting the output voltage from the inverter 310, specifically, by including a third-order harmonic component therein. As a result, the power converter 1 can increase the high speed range of the motor 314.

Constant torque control provides a constant torque applied from the inverter 310 to the motor 314. The constant torque control is also called constant current control. Even for a system with the load torque variation the amount of vibration is not so high when the system is operated in a relatively light load range. With the constant torque applied from the inverter 310, thus, the current waveform of the motor 314 is sinusoidal, i.e., a waveform without a ripple, thereby obtaining the high efficiency operation. Note that the constant torque control can be also used in a high load range in which vibration is allowable.

Power supply ripple compensation control reduces a ripple current caused by a power supply ripple flowing through the capacitor 210 of the smoothing unit 200 as described above. The ripple current caused by the power supply ripple passes through the capacitor 210 and transmits power to the load, thereby reducing stress on the capacitor 210.

The operation mode, that is, the operation of the power converter 1 by the control unit 400, is determined by a combination of the presence or absence of each of: the operation of the rectifying and boosting unit 700; the vibration reduction control that reduces the vibration of the motor 314 or the device equipped with the motor 314; the overmodulation control of the inverter 310; the constant torque control on the motor 314; and the power supply ripple compensation control that reduces the charge/discharge current through the capacitor 210. The control unit 400 determines the presence or absence of each control illustrated in FIGS. 6 and 7 in accordance with the load state. That is, the control unit 400 maintains or switches the operation mode, determining the presence or absence of each control in accordance with the load state. Note that FIGS. 6 and 7 list the operation modes each defined by the specific five items by way of example, and the present disclosure is not limited thereto. Some of these five items may be set as target controls, or an item other than the five items may be further set as a target control. The item other than the five items includes, for example, flux weakening control. That is, the operation may include the flux weakening control. The flux weakening control expands the high speed range of the motor 314 by reducing the apparent electromotive force with a negative d-axis current applied to the motor 314.

For the load state, the power converter 1 can detect the current values such as the current I1 by a detected value of the current detection unit 501 and the current I2 by a detected value of the current detection unit 502. Also for the load state, for example, the power converter 1 installed in the air conditioner can detect the temperature by a detected value of a temperature sensor of an indoor unit of the air conditioner, a detected value of a temperature sensor of the outdoor unit, or the like. Note that the power converter 1 may include a temperature sensor around a substrate of the inverter 310 to detect a temperature around the substrate of the inverter 310, or may include a temperature sensor around the motor 314 to detect a temperature around the motor 314. Moreover, for the load state, the power converter 1 can directly or indirectly detect an operation speed such as an operation speed of the motor 314 of the compressor 315, a fan (not illustrated) installed in the air conditioner, etc. from a command value generated in the process of control of the control unit 400, an estimated value estimated from an operating frequency in the process of control of the control unit 400, etc. As described above, the load state is obtained by at least one of: the detected value of the detection unit that detects the physical quantity from the inverter 310, the motor 314, or the compressor 315; the command value generated in the process of control of the control unit 400; and the estimated value estimated in the process of control of the control unit 400. The physical quantity may be, for example, a voltage value in addition to the current value and the temperature described above.

A description will be hereinafter made of an overview of each operation mode illustrated in FIGS. 6 and 7 in a case where the power converter 1 is installed in the air conditioner as the refrigeration cycle applied apparatus.

An operation mode 1 is a combination of: the absence of the boosting operation; the absence of the vibration reduction control; the absence of the overmodulation control; the absence of the constant torque control; and the absence of the power supply ripple compensation control. The operation mode 1 is used, for example, when the boosting operation is not performed, the mechanically induced vibration is low, the motor voltage does not reach saturation, and the load current ripple and the power supply current ripple are low.

An operation mode 2 is a combination of: the absence of the boosting operation; the absence of the vibration reduction control; the absence of the overmodulation control; the absence of the constant torque control; and the presence of the power supply ripple compensation control. The operation mode 2 is used, for example, when the boosting operation is not performed, the mechanically induced vibration is low, the motor voltage does not reach saturation, and the load current ripple is low, but the power supply current ripple is to be reduced.

An operation mode 3 is a combination of: the absence of the boosting operation; the presence of the vibration reduction control; the absence of the overmodulation control; the absence of the constant torque control; and the absence of the power supply ripple compensation control. The operation mode 3 is used, for example, when the boosting operation is not performed, the motor voltage does not reach saturation, and the load current ripple and the power supply current ripple are low, but the mechanically induced vibration is to be reduced.

An operation mode 4 is a combination of: the absence of the boosting operation; the presence of the vibration reduction control; the absence of the overmodulation control; the absence of the constant torque control; and the presence of the power supply ripple compensation control. The operation mode 4 is used, for example, when the boosting operation is not performed, the motor voltage does not reach saturation, and the load current ripple is low, but the mechanically induced vibration and the power supply current ripple are to be reduced.

An operation mode 5 is a combination of: the absence of the boosting operation; the absence of the vibration reduction control; the presence of the overmodulation control; the absence of the constant torque control; and the absence of the power supply ripple compensation control. The operation mode 5 is used, for example, when the boosting operation is not performed, the mechanically induced vibration is low, and the load current ripple and the power supply current ripple are low, but measures against saturation of the motor voltage are to be taken.

An operation mode 6 is a combination of: the absence of the boosting operation; the absence of the vibration reduction control; the presence of the overmodulation control; the absence of the constant torque control; and the presence of the power supply ripple compensation control. The operation mode 6 is used, for example, when the boosting operation is not performed, the mechanically induced vibration is low, and the load current ripple is low, but measures against saturation of the motor voltage are to be taken, and the power supply current ripple is to be reduced.

An operation mode 7 is a combination of: the absence of the boosting operation; the presence of the vibration reduction control; the presence of the overmodulation control; the absence of the constant torque control; and the absence of the power supply ripple compensation control. The operation mode 7 is used, for example, when the boosting operation is not performed, and the load current ripple and the power supply current ripple are low, but the mechanically induced vibration is to be reduced, and measures against saturation of the motor voltage are to be taken.

An operation mode 8 is a combination of: the absence of the boosting operation; the presence of the vibration reduction control; the presence of the overmodulation control; the absence of the constant torque control; and the presence of the power supply ripple compensation control. The operation mode 8 is used, for example, when the boosting operation is not performed, and the load current ripple is low, but the mechanically induced vibration is to be reduced, and measures against saturation of the motor voltage and against the power supply current ripple are to be taken.

An operation mode 9 is a combination of: the absence of the boosting operation; the absence of the vibration reduction control; the absence of the overmodulation control; the presence of the constant torque control; and the absence of the power supply ripple compensation control. The operation mode 9 is used, for example, when the boosting operation is not performed, the mechanically induced vibration is low, the motor voltage does not reach saturation, and the power supply current ripple is low, but a reduction in efficiency due to the load current ripple is to be prevented (i.e., energy-saving operation is to be achieved).

An operation mode 10 is a combination of: the absence of the boosting operation; the absence of the vibration reduction control; the absence of the overmodulation control; the presence of the constant torque control; and the presence of the power supply ripple compensation control. The operation mode 10 is used, for example, when the boosting operation is not performed, the mechanically induced vibration is low, and the motor voltage does not reach saturation, but a reduction in efficiency due to the load current ripple is to be prevented (i.e., energy-saving operation is to be achieved), and the power supply current ripple is to be reduced.

An operation mode 11 is a combination of: the absence of the boosting operation; the absence of the vibration reduction control; the presence of the overmodulation control; the presence of the constant torque control; and the absence of the power supply ripple compensation control. The operation mode 11 is used, for example, when the boosting operation is not performed, the mechanically induced vibration is low, and the power supply current ripple is low, but measures against saturation of the motor voltage are to be taken, and a reduction in efficiency due to the load current ripple is to be prevented (i.e., energy-saving operation is to be achieved).

An operation mode 12 is a combination of: the absence of the boosting operation; the absence of the vibration reduction control; the presence of the overmodulation control; the presence of the constant torque control; and the presence of the power supply ripple compensation control. The operation mode 12 is used, for example, when the boosting operation is not performed, and the mechanically induced vibration is low, but measures against saturation of the motor voltage are to be taken, a reduction in efficiency due to the load current ripple is to be prevented (i.e., energy-saving operation is to be achieved), and measures against the power supply current ripple are to be taken.

An operation mode 13 is a combination of: the presence of the boosting operation; the absence of the vibration reduction control; the absence of the overmodulation control; the absence of the constant torque control; and the absence of the power supply ripple compensation control. The operation mode 13 is used, for example, when, at the time of the boosting operation, the mechanically induced vibration is low, the motor voltage does not reach saturation, and the load current ripple and the power supply current ripple are low.

An operation mode 14 is a combination of: the presence of the boosting operation; the absence of the vibration reduction control; the absence of the overmodulation control; the absence of the constant torque control; and the presence of the power supply ripple compensation control. The operation mode 14 is used, for example, when, at the time of the boosting operation, the mechanically induced vibration is low, the motor voltage does not reach saturation, and the load current ripple is low, but the power supply current ripple is to be reduced.

An operation mode 15 is a combination of: the presence of the boosting operation; the presence of the vibration reduction control; the absence of the overmodulation control; the absence of the constant torque control; and the absence of the power supply ripple compensation control. The operation mode 15 is used, for example, when, at the time of the boosting operation, the motor voltage does not reach saturation, and the load current ripple and the power supply current ripple are low, but the mechanically induced vibration is to be reduced.

An operation mode 16 is a combination of: the presence of the boosting operation; the presence of the vibration reduction control; the absence of the overmodulation control; the absence of the constant torque control; and the presence of the power supply ripple compensation control. The operation mode 16 is used, for example, when, at the time of the boosting operation, the motor voltage does not reach saturation, and the load current ripple is low, but the mechanically induced vibration and the power supply current ripple are to be reduced.

An operation mode 17 is a combination of: the presence of the boosting operation; the absence of the vibration reduction control; the presence of the overmodulation control; the absence of the constant torque control; and the absence of the power supply ripple compensation control. The operation mode 17 is used, for example, when, at the time of the boosting operation, the mechanically induced vibration is low, and the load current ripple and the power supply current ripple are low, but measures against saturation of the motor voltage are to be taken.

An operation mode 18 is a combination of: the presence of the boosting operation; the absence of the vibration reduction control; the presence of the overmodulation control; the absence of the constant torque control; and the presence of the power supply ripple compensation control. The operation mode 18 is used, for example, when, at the time of the boosting operation, the mechanically induced vibration is low, and the load current ripple is low, but measures against saturation of the motor voltage are to be taken, and the power supply current ripple is to be reduced.

An operation mode 19 is a combination of: the presence of the boosting operation; the presence of the vibration reduction control; the presence of the overmodulation control; the absence of the constant torque control; and the absence of the power supply ripple compensation control. The operation mode 19 is used, for example, when, at the time of the boosting operation, the load current ripple and the power supply current ripple are low, but the mechanically induced vibration is to be reduced, and measures against saturation of the motor voltage are to be taken.

An operation mode 20 is a combination of: the presence of the boosting operation; the presence of the vibration reduction control; the presence of the overmodulation control; the absence of the constant torque control; and the presence of the power supply ripple compensation control. The operation mode 20 is used, for example, when, at the time of the boosting operation, the load current ripple is low, but the mechanically induced vibration is to be reduced, and measures against saturation of the motor voltage and against the power supply current ripple are to be taken.

An operation mode 21 is a combination of: the presence of the boosting operation; the absence of the vibration reduction control; the absence of the overmodulation control; the presence of the constant torque control; and the absence of the power supply ripple compensation control. The operation mode 21 is used, for example, when, at the time of the boosting operation, the mechanically induced vibration is low, the motor voltage does not reach saturation, and the power supply current ripple is low, but a reduction in efficiency due to the load current ripple is to be prevented (i.e., energy-saving operation is to be achieved).

An operation mode 22 is a combination of: the presence of the boosting operation; the absence of the vibration reduction control; the absence of the overmodulation control; the presence of the constant torque control; and the presence of the power supply ripple compensation control. The operation mode 22 is used, for example, when, at the time of the boosting operation, the mechanically induced vibration is low, and the motor voltage does not reach saturation, but a reduction in efficiency due to the load current ripple is to be prevented (i.e., energy-saving operation is to be achieved), and the power supply current ripple is to be reduced.

An operation mode 23 is a combination of: the presence of the boosting operation; the absence of the vibration reduction control; the presence of the overmodulation control; the presence of the constant torque control; and the absence of the power supply ripple compensation control. The operation mode 23 is used, for example, when, at the time of the boosting operation, the mechanically induced vibration is low, and the power supply current ripple is low, but measures against saturation of the motor voltage are to be taken, and a reduction in efficiency due to the load current ripple is to be prevented (i.e., energy-saving operation is to be achieved).

An operation mode 24 is a combination of: the presence of the boosting operation; the absence of the vibration reduction control; the presence of the overmodulation control; the presence of the constant torque control; and the presence of the power supply ripple compensation control. The operation mode 24 is used, for example, when, at the time of the boosting operation, the mechanically induced vibration is low, but measures against saturation of the motor voltage are to be taken, a reduction in efficiency due to the load current ripple is to be prevented (i.e., energy-saving operation is to be achieved), and measures against the power supply current ripple are to be taken.

In the operation modes 1 to 24, the control unit 400 can for example determine the presence or absence of the power supply ripple compensation control in accordance with the capacitance of the capacitor 210. The control unit 400 can also determine the presence or absence of the vibration reduction control in accordance with the amount of work done by the device, i.e., the compressor 315 equipped with the motor 314.

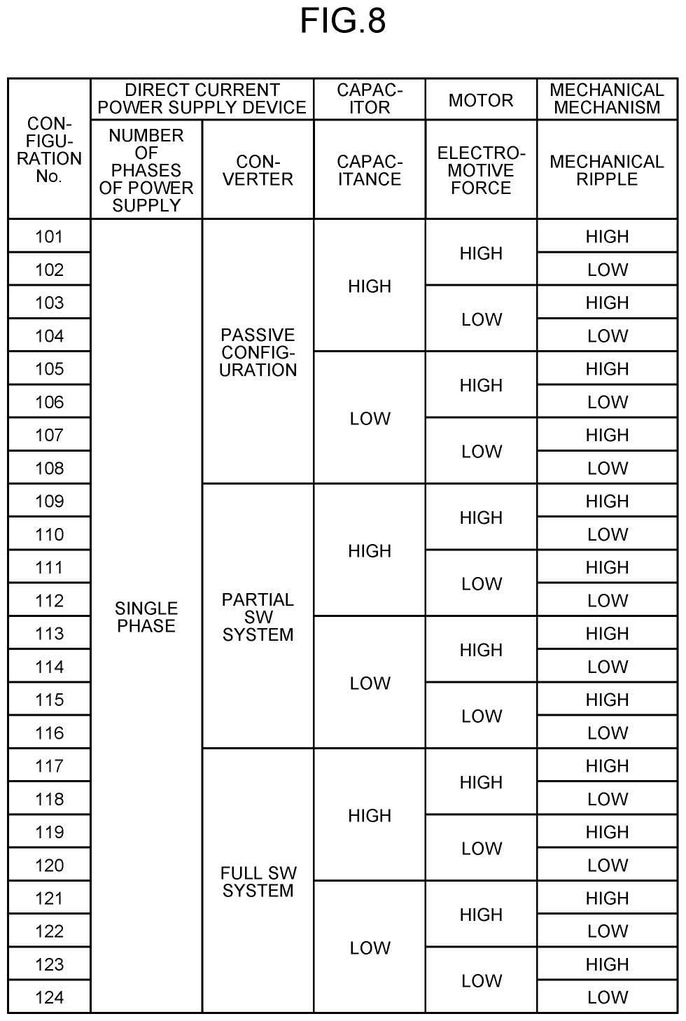

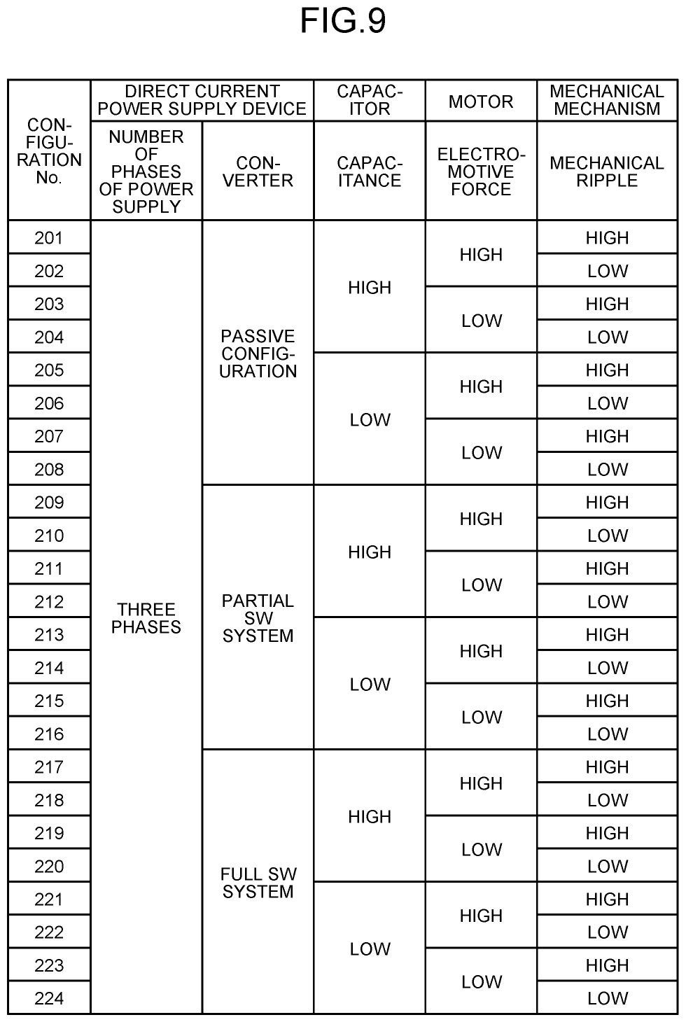

When installed in the air conditioner as described above, the power converter 1 can also determine the operation mode in accordance with air-conditioning conditions of the air conditioner. FIG. 8 is a first table illustrating examples of a hardware configuration of the air conditioner equipped with the power converter 1 according to the first embodiment. FIG. 9 is a second table illustrating examples of the hardware configuration of the air conditioner equipped with the power converter 1 according to the first embodiment. FIG. 8 illustrates the power converter 1 connected to a single-phase commercial power supply 110, and FIG. 9 illustrates the power converter 1 connected to a three-phase commercial power supply 110. Components illustrated in FIGS. 8 and 9, include the number of phases of power supply, a converter, the capacitor 210, the motor 314, and a mechanical mechanism. Note that in FIGS. 8 and 9, the number of phases of power supply and the converter are collectively referred to as a direct current power supply device.

Regarding the number of phases of power supply, a power supply such as the commercial power supply 110 has a single phase or multiple phases. In the case of multiple phases, three phases are common. The single-phase power supply is used in a relatively small electrical product such as a home appliance. The three-phase power supply is used in a relatively large electrical product such as industrial electrical equipment. Models of air conditioners using the single-phase power supply mainly include a room air conditioner, a commercial air conditioner, and the like. Models of air conditioners using the three-phase power supply mainly include a commercial air conditioner, a commercial multi air conditioner, and the like.

The converter, which is a component for converting alternating-current power into direct-current power, corresponds to, for example, the rectifying and boosting units 700, 701, and 702 described above. The converter includes a passive configuration and a switch system (hereinafter referred to as an SW system). The passive configuration converts the alternating-current power into the direct-current power by rectifying the alternating-current power. The SW system performs switching before or after rectification to thereby vary a direct-current voltage or improve a power supply's power factor, power supply harmonics, etc. The passive configuration mainly includes, a reactor and a rectifier. The passive configuration is like the rectifying and boosting unit 700 of the power converter 1 of FIG. 1 with the switching element 632 removed. The SW system mainly includes, a reactor, a rectifier, a switching element, a backflow prevention element, etc. For some configuration of the SW system, the switching element and the backflow prevention element serve as the rectifier. The SW system operates as a partial SW system and a full SW system. The partial SW system performs switching partially with respect to a power supply cycle. The full SW system performs switching over the entire power supply cycle. The partial SW system, which is the simple switching described above, switches the operation of the switching element. The full SW system, which is the full PAM described above, allows the switching element to operate constantly. Which one of the partial SW system and the full SW system should be used depends on, for example, regulations on the power supply harmonics. For example, a model to be shipped to an area imposing relatively strict regulations on the power supply harmonics has the converter constantly operated with the full SW system to improve the power supply harmonics for both a light load and a heavy load. On the other hand, a model to be shipped to an area imposing relatively loose regulations on the power supply harmonics has the converter operated with the partial SW system only in a necessary load range to improve the power supply harmonics. Which one of the partial SW system and the full SW system should be used depends on, for example, the operating range of the air conditioner. In order to expand the operating range of the air conditioner for the high load range, the direct-current voltage applied to the load needs to be boosted. For this purpose, the full SW system capable of increasing a boost ratio is preferable. The full SW system, which allows the converter to operate constantly, has an advantage that an inductance value of the reactor can be reduced, but has a disadvantage that a switching loss occurs. The partial SW system, which allows the converter to operate only in the necessary load range, has an advantage that the switching loss can be reduced, but has a disadvantage that the inductance value of the reactor needs to be increased.

The capacitor 210 is the electrolytic capacitor, the film capacitor, etc. as described above. The motor 314 is installed on the compressor 315 as described above.

The mechanical mechanism refers to a mechanism of the compressor 315. The compressor 315 used in the air conditioner includes a rotary compressor, a scroll compressor, etc. The rotary compressor includes a single rotary type and a twin rotary type. The structure of the single rotary type includes one cylinder, which prominently shows vibration having the frequency of 1f in a rotation period. The structure of the twin rotary type includes two cylinders, which prominently shows vibration having the frequency of 2f in the rotation period. The scroll compressor is of a scroll type having a spiral element called a fixed scroll type, an orbiting scroll type, etc. For the scroll compressor, if to 3f vibrations in the rotation period are prominent, but peaks of the vibrations are dispersed. Vibration tends to be the largest with the single rotary type, followed in order by the twin rotary type and the scroll type. Cost tends to be the lowest with the single rotary type, followed in order by the twin rotary type and the scroll type.

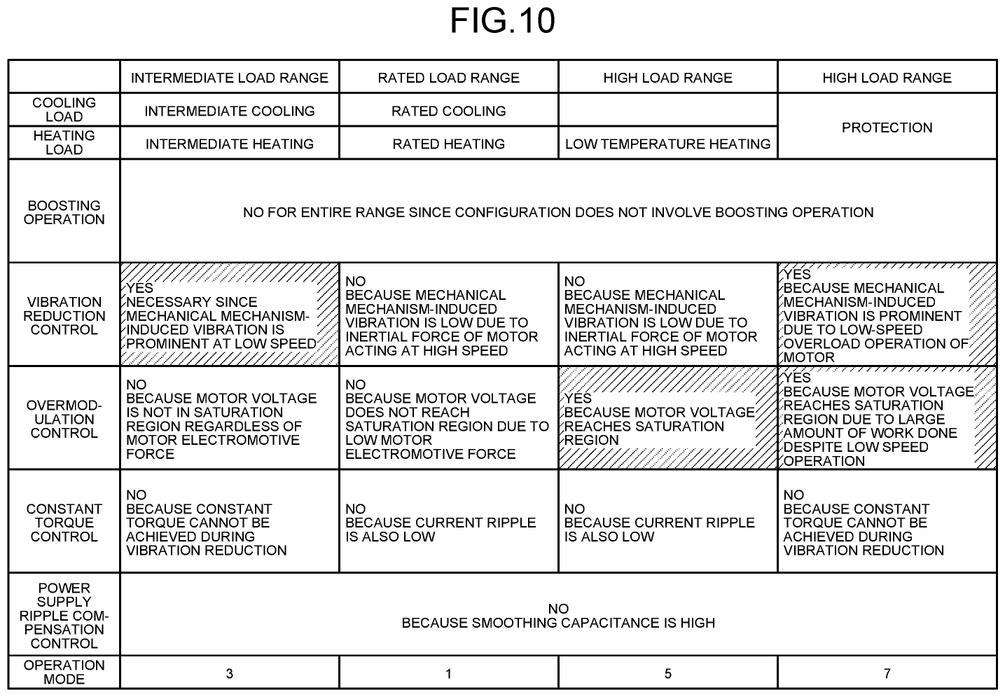

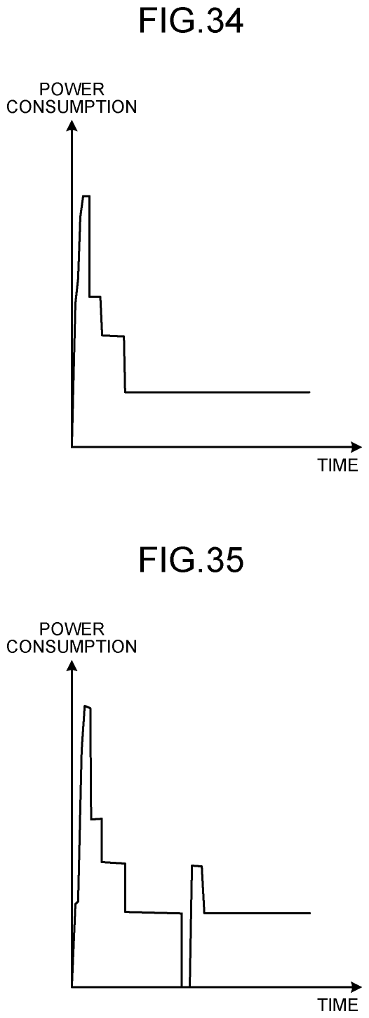

FIGS. 10 to 33 are tables illustrating relationships between the air-conditioning conditions in the configurations of models compatible with the single-phase power supply illustrated in FIG. 8 and the operation modes illustrated in FIGS. 6 and 7 regarding the air conditioner equipped with the power converter 1 according to the first embodiment. Details of FIGS. 10 to 33 will be described later. FIG. 34 is a graph illustrating an example of a change in power consumption during cooling operation of the air conditioner equipped with the power converter 1 according to the first embodiment. FIG. 35 is a graph illustrating an example of a change in power consumption during heating operation of the air conditioner equipped with the power converter 1 according to the first embodiment. In FIGS. 34 and 35, horizontal axes represent time, and vertical axes represent power consumption. The air-conditioning conditions of the air conditioner illustrated in FIGS. 10 to 33 include intermediate cooling, rated cooling, intermediate heating, rated heating, and low temperature heating, and further include a mode for shifting to protection from the air-conditioning conditions including the rated cooling and the rated heating corresponding to a rated load range, and the low temperature heating corresponding to the high load range. Note that the intermediate cooling and intermediate heating air-conditioning conditions collectively correspond to an intermediate load range.

As illustrated in FIG. 34, right after the operation starts in a cooling operation mode by a user operation, a room temperature and a set temperature are apart from each other. The compressor 315 is in a state that provides a large amount of work as the motor 314 operates at high speed. Such a state represents the air-conditioning condition called the rated cooling, and power consumption is high in this state. When the operation is sufficiently performed at the rated cooling, the room temperature and the set temperature are close to each other. The compressor 315 enters a state that provides a small amount of work as the motor 314 shifts to low speed operation. Such a state represents the air-conditioning condition called the intermediate cooling, and power consumption is low in this state. Moreover, under the load condition of the rated cooling, the rotational speed of the motor 314 in the compressor 315 may temporarily shift from high speed to low speed for the purpose of protecting the temperature in a thermal cycle or the like. When such a protection operation is performed, the amount of work done by the compressor 315 is relatively large although the motor 314 rotates at low speed.

Also, as illustrated in FIG. 35, right after the operation starts in a heating operation mode by a user operation, a room temperature and a set temperature are apart from each other. The compressor 315 is in a state that provides a large amount of work as the motor 314 operates at high speed. Such a state represents the air-conditioning condition called the rated heating, and power consumption is high in this state. The heating operation includes the air-conditioning condition called the low temperature heating that is an operation mode in an environment where the outside temperature is lower than that at the time of the rated heating. The low temperature heating has a higher load and higher power consumption than the rated heating. Moreover, under the air-conditioning condition such as the rated heating or the low temperature heating, the rotational speed of the motor 314 in the compressor 315 may temporarily shift from high speed to low speed for the purpose of protecting the temperature in the thermal cycle or the like. When such a protection operation is performed, the amount of work done by the compressor 315 is relatively large although the motor 314 rotates at low speed. Moreover, the heating operation has a phenomenon called frosting in which frost forms on a heat exchanger part of an outdoor unit. Frosting hinders heat exchange, increases the load, and makes it harder to achieve an air conditioning effect of the air conditioner. For this reason, operation for removing frost called defrosting may be performed. Although power consumption of the defrosting operation itself is small, the heating operation cannot be performed in the room during the defrosting operation, which causes the room temperature to drop so that the operation is performed at a relatively high load after the heating operation resumes.

A description will be made as to switching of the operation mode in response to the aforementioned changes in the air-conditioning condition. Note that although the description will be made with the air conditioner as an actor, the control unit 400 of the power converter 1 in practice controls switching the operation mode in accordance with the air-conditioning condition. The control unit 400 controls operation of the power converter in accordance with the air-conditioning condition of the air conditioner. The air-conditioning condition includes at least one of the intermediate cooling, the rated cooling, the intermediate heating, the rated heating, and the low temperature heating. The control unit 400 can directly or indirectly acquire the air-conditioning condition from a user's setting on the air conditioner, a temperature of the outside where an outdoor unit of the air conditioner is installed, a temperature in a room where an indoor unit of the air conditioner is installed, an operating time of the air conditioner, etc. The control unit 400 may acquire the air-conditioning condition using all or at least one of these.

FIG. 10 is a table illustrating relationships between the air-conditioning conditions and the operation modes in a case where the air conditioner equipped with the power converter 1 according to the first embodiment has a configuration 101. The configuration 101 has a relatively simple hardware configuration among those which support the single-phase power supply. The direct current power supply device part includes the rectifier for a single phase and the converter having the passive configuration having the reactor provided at a state preceding or following the rectifier. The direct current power supply device part in the configuration 101 is like the rectifying and boosting unit 700 of the power converter 1 illustrated in FIG. 1 with the switching element 632, the diode 633, etc. removed. The capacitance of the capacitor 210 is relatively high. The electromotive force of the motor 314 in the compressor 315 is relatively high. The mechanical mechanism of the compressor 315 is the single rotary type or the like, and the mechanical ripple is relatively high.

In the case of the cooling operation of the air conditioner of the configuration 101, the air conditioner is in the operation mode 1 as the air conditioner operates at the rated cooling immediately after the start of the operation. After that, when the room temperature approaches a set temperature, the air conditioner switches from the rated cooling to the intermediate cooling on the basis of a switching condition such as a set threshold for a difference between the room temperature and the set temperature. When switching to the intermediate cooling, the air conditioner switches to the operation mode 3 with the vibration reduction control because vibration caused by the mechanical mechanism becomes prominent in low speed operation. The air conditioner switches to the operation mode 7 in the case of shifting to protection. Moreover, in the case of the heating operation, the air conditioner is in the operation mode 1 as the air conditioner operates at the rated heating immediately after the start of the operation. Alternatively, the air conditioner operates at the low temperature heating, depending on the outside temperature, such that the air conditioner operates in the operation mode 5. After that, when the room temperature approaches a set temperature, the air conditioner switches from the rated heating to the intermediate heating on the basis of a switching condition such as a threshold set for a difference between the room temperature and the set temperature. When switching to the intermediate heating, the air conditioner switches to the operation mode 3 with the vibration reduction control because vibration caused by the mechanical mechanism becomes prominent in low speed operation. The air conditioner switches to the operation mode 7 in the case of shifting to protection. Before and after the defrosting operation, the air conditioner has a high load and thus operates in the operation mode 1 or the operation mode 5, depending on the outside temperature. By switching the operation mode among the operation mode 1, the operation mode 3, the operation mode 5, and the operation mode 7, as described above, the air conditioner of the configuration 101 can provide a product operation optimum for each air-conditioning condition.

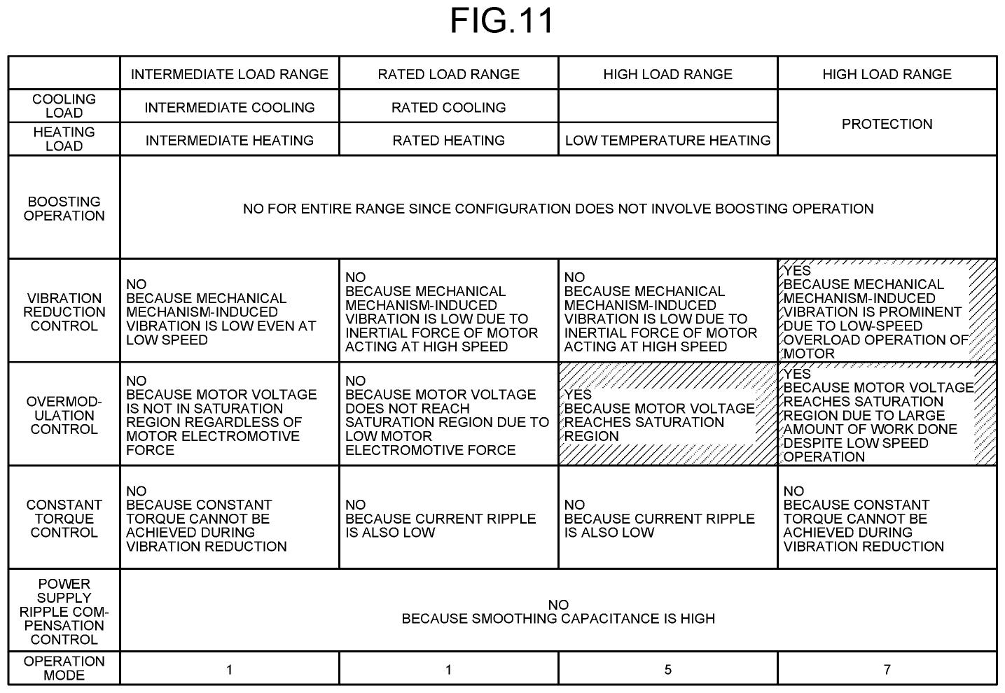

FIG. 11 is a table illustrating the relationships between the air-conditioning conditions and the operation modes in a case where the air conditioner equipped with the power converter 1 according to the first embodiment has a configuration 102. In the configuration 102, as compared to the configuration 101, the mechanical mechanism of the compressor 315 is the twin rotary type, the scroll type, etc. and the mechanical ripple is relatively low. The air conditioner of the configuration 102 is different from that of the configuration 101 in that the air conditioner of the configuration 102 operates in the operation mode 1 for the intermediate load range.

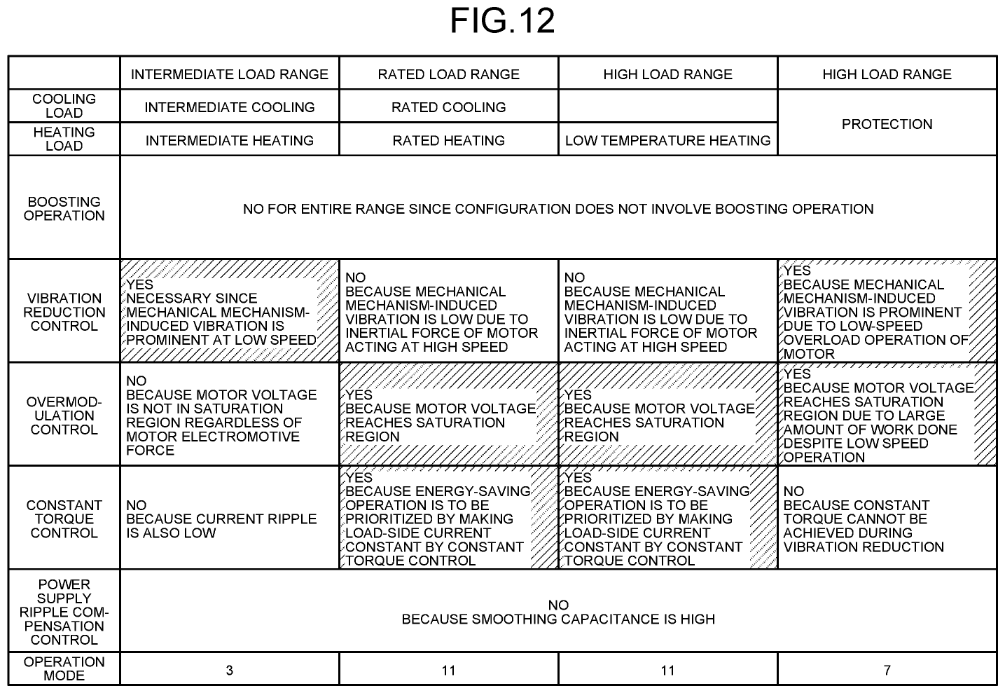

FIG. 12 is a table illustrating the relationships between the air-conditioning conditions and the operation modes in a case where the air conditioner equipped with the power converter 1 according to the first embodiment has a configuration 103. In the configuration 103, as compared to the configuration 101, the motor electromotive force is improved, that is, reduced by, for example, increasing the number of turns in the motor 314. The air conditioner of the configuration 103 is different from that of the configuration 101 in that the air conditioner of the configuration 103 operates in the operation mode 11 for the rated load range and the low temperature heating.

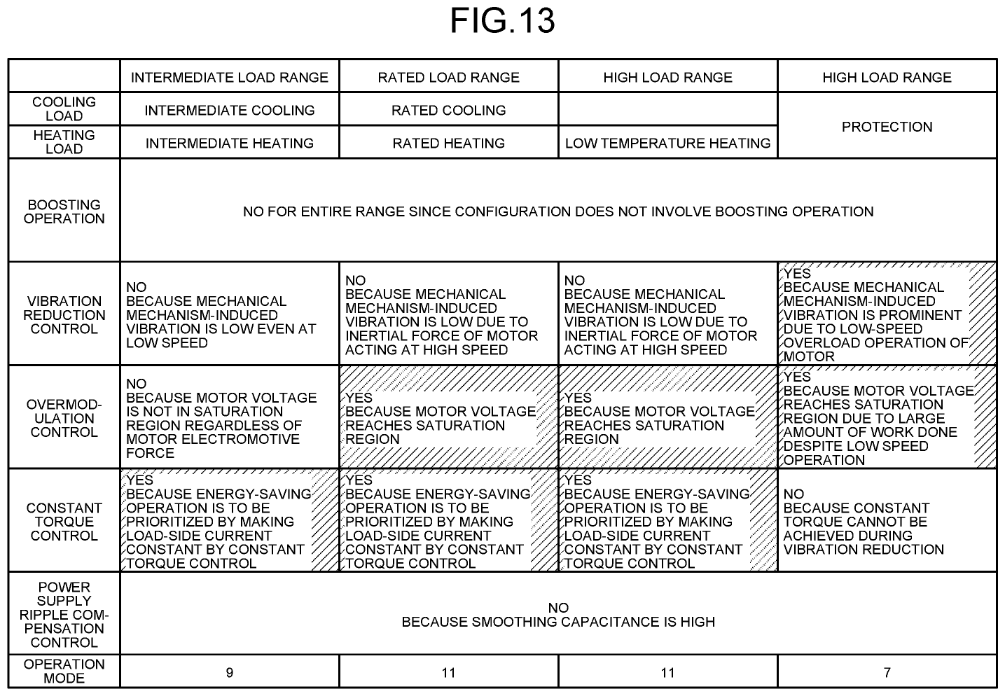

FIG. 13 is a table illustrating the relationships between the air-conditioning conditions and the operation modes in a case where the air conditioner equipped with the power converter 1 according to the first embodiment has a configuration 104. In the configuration 104, as compared to the configuration 103, the mechanical mechanism of the compressor 315 is the twin rotary type, the scroll type, etc., and the mechanical ripple is relatively low. The air conditioner of the configuration 104 is different from that of the configuration 103 in that the air conditioner of the configuration 104 operates in the operation mode 9 for the intermediate load range.

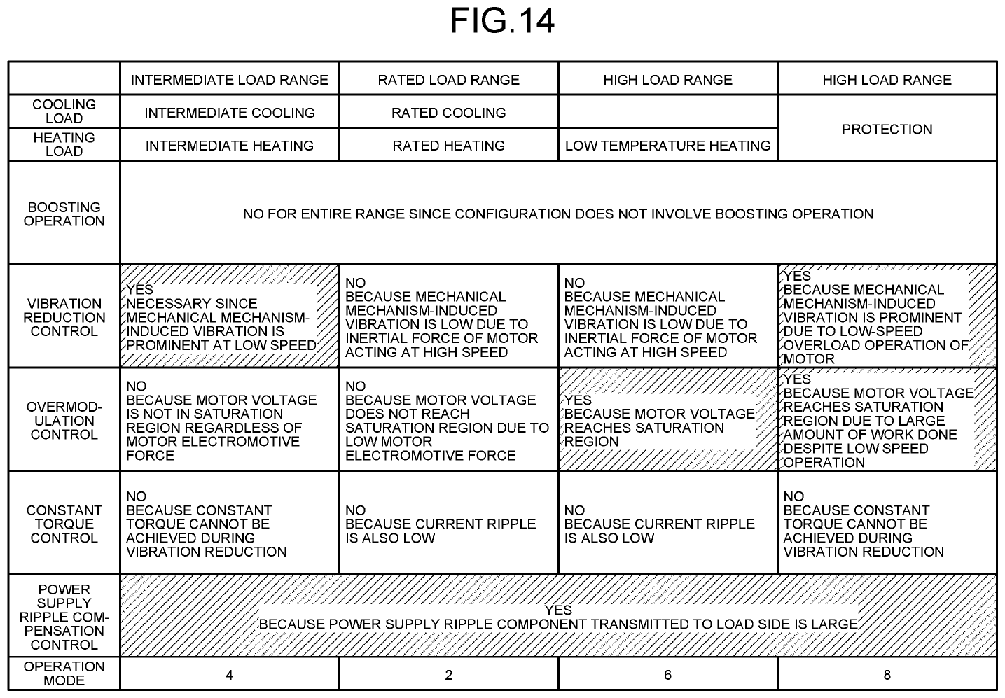

FIG. 14 is a table illustrating the relationships between the air-conditioning conditions and the operation modes in a case where the air conditioner equipped with the power converter 1 according to the first embodiment has a configuration 105. In the configuration 105, the capacitance of the capacitor 210 is reduced as compared to the configuration 101. The air conditioner of the configuration 105 is different from that of the configuration 101 in respect of the presence or absence of the power supply ripple compensation control. As a result, while the air conditioner of the configuration 101 operates in the operation mode 1, the operation mode 3, the operation mode 5, and the operation mode 7, the air conditioner of the configuration 105 operates in the operation mode 2, the operation mode 4, the operation mode 6, and the operation mode 8, respectively.

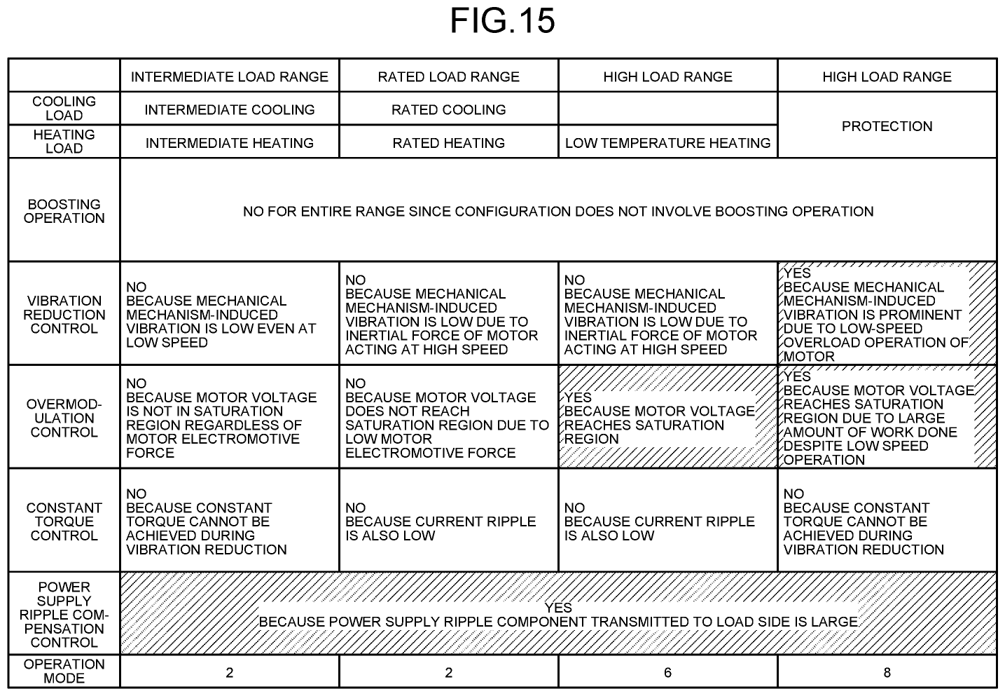

FIG. 15 is a table illustrating the relationships between the air-conditioning conditions and the operation modes in a case where the air conditioner equipped with the power converter 1 according to the first embodiment has a configuration 106. In the configuration 106, as compared to the configuration 105, the mechanical mechanism of the compressor 315 is the twin rotary type, the scroll type, etc., and the mechanical ripple is relatively low. The air conditioner of the configuration 106 is different from that of the configuration 105 in that the air conditioner of the configuration 106 operates in the operation mode 2 for the intermediate load range.

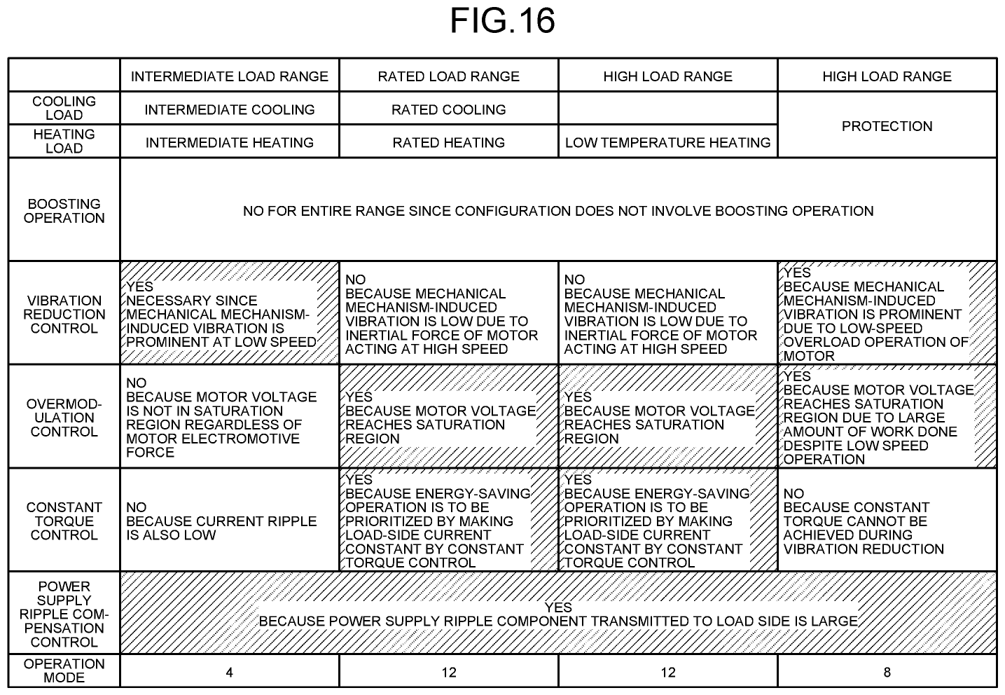

FIG. 16 is a table illustrating the relationships between the air-conditioning conditions and the operation modes in a case where the air conditioner equipped with the power converter 1 according to the first embodiment has a configuration 107. In the configuration 107, as compared to the configuration 105, the motor electromotive force is improved, that is, reduced by, for example, increasing the number of turns in the motor 314. The air conditioner of the configuration 107 is different from that of the configuration 105 in that the air conditioner of the configuration 107 operates in the operation mode 12 for the rated load range and the low temperature heating.

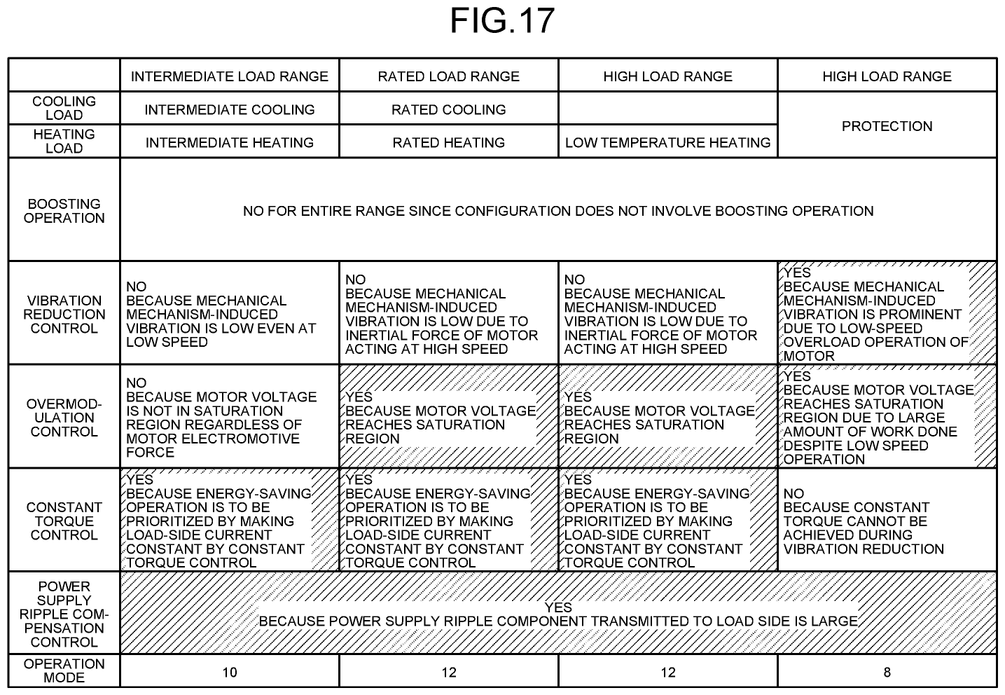

FIG. 17 is a table illustrating the relationships between the air-conditioning conditions and the operation modes in a case where the air conditioner equipped with the power converter 1 according to the first embodiment has a configuration 108. In the configuration 108, as compared to the configuration 107, the mechanical mechanism of the compressor 315 is the twin rotary type, the scroll type, etc., and the mechanical ripple is relatively low. The air conditioner of the configuration 108 is different from that of the configuration 107 in that the air conditioner of the configuration 108 operates in the operation mode 10 for the intermediate load range.

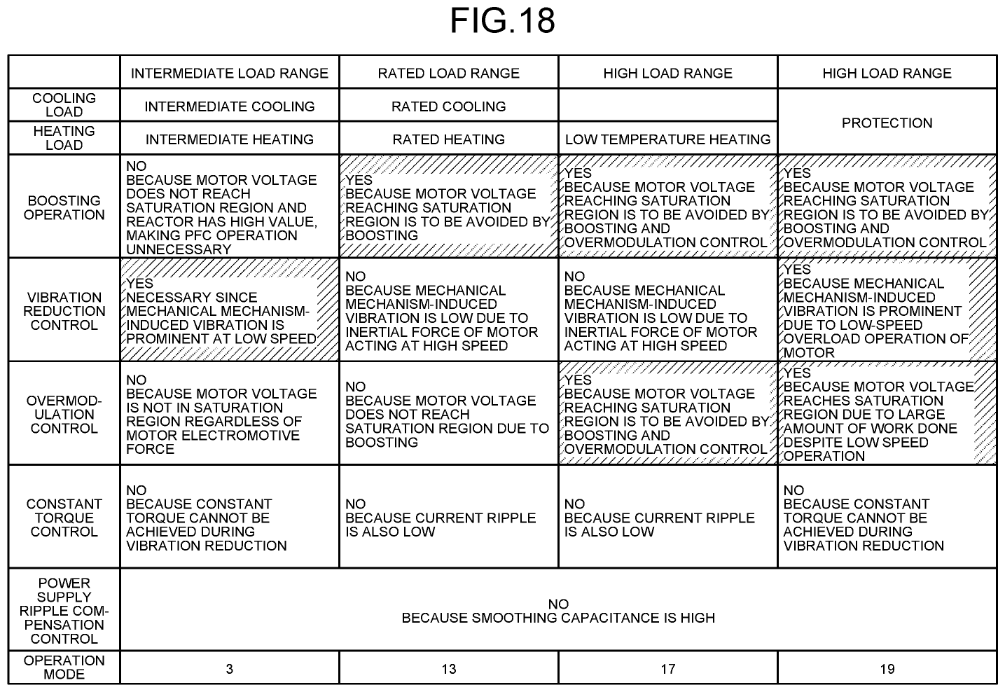

FIG. 18 is a table illustrating the relationships between the air-conditioning conditions and the operation modes in a case where the air conditioner equipped with the power converter 1 according to the first embodiment has a configuration 109. In the configuration 109, as compared to the configuration 101, the converter is changed from the passive configuration to the partial SW system. The air conditioner of the configuration 109 is different from that of the configuration 101 in respect of the presence or absence of the boosting operation. As a result, while the air conditioner of the configuration 101 operates in the operation mode 1, the operation mode 3, the operation mode 5, and the operation mode 7, the air conditioner of the configuration 109 operates in the operation mode 13, the operation mode 3, the operation mode 17, and the operation mode 19, respectively.

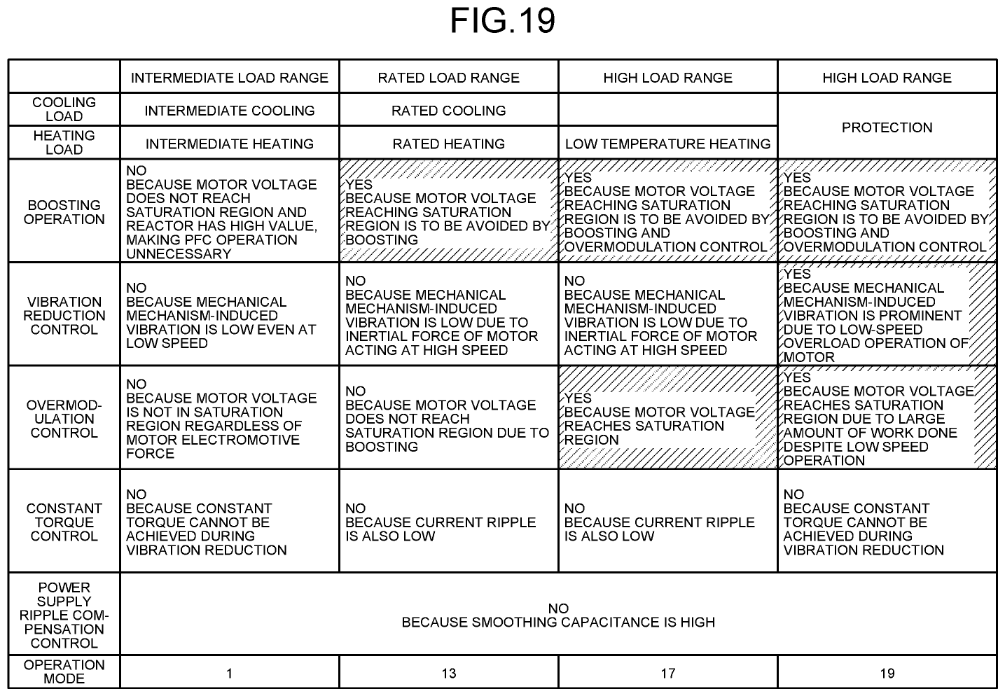

FIG. 19 is a table illustrating the relationships between the air-conditioning conditions and the operation modes in a case where the air conditioner equipped with the power converter 1 according to the first embodiment has a configuration 110. In the configuration 110, as compared to the configuration 109, the mechanical mechanism of the compressor 315 is the twin rotary type, the scroll type, etc., and the mechanical ripple is relatively low. The air conditioner of the configuration 110 is different from that of the configuration 109 in that the air conditioner of the configuration 110 operates in the operation mode 1 for the intermediate load range.

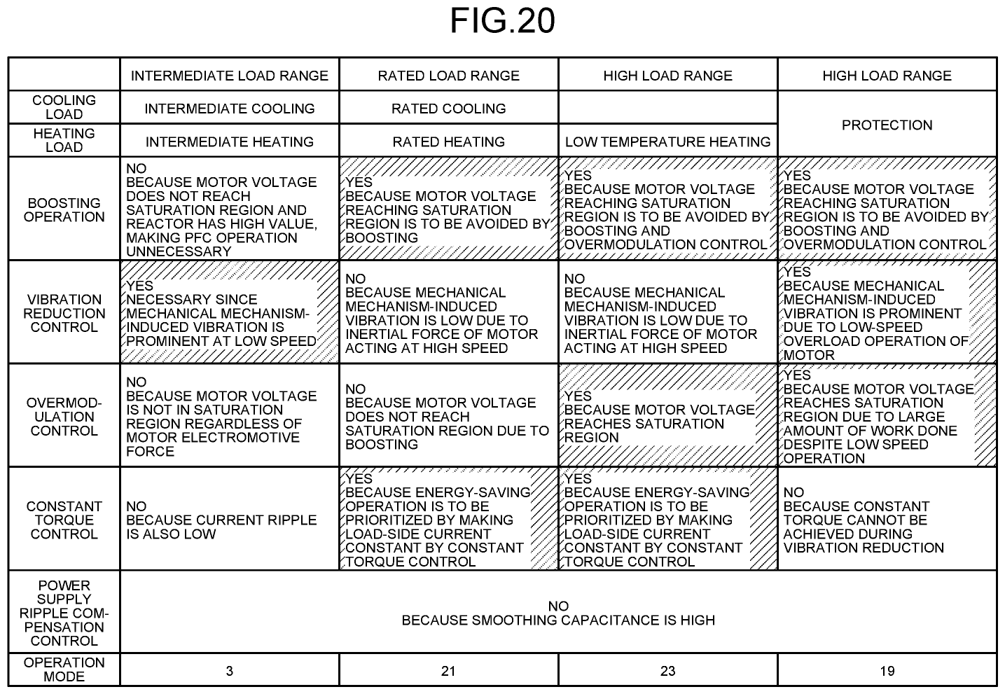

FIG. 20 is a table illustrating the relationships between the air-conditioning conditions and the operation modes in a case where the air conditioner equipped with the power converter 1 according to the first embodiment has a configuration 111. In the configuration 111, as compared to the configuration 109, the motor electromotive force is improved, that is, reduced by, for example, increasing the number of turns in the motor 314. The air conditioner of the configuration 111 is different from that of the configuration 109 in that the air conditioner of the configuration 111 operates in the operation mode 21 for the rated load range and operates in the operation mode 23 for the low temperature heating.

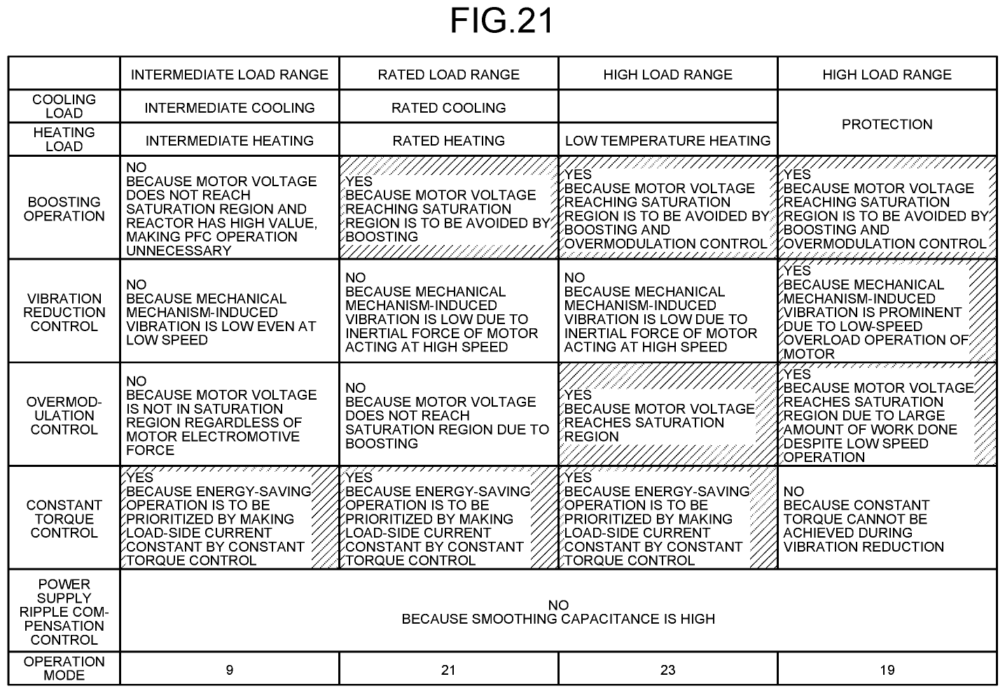

FIG. 21 is a table illustrating the relationships between the air-conditioning conditions and the operation modes in a case where the air conditioner equipped with the power converter 1 according to the first embodiment has a configuration 112. In the configuration 112, as compared to the configuration 111, the mechanical mechanism of the compressor 315 is the twin rotary type, the scroll type, etc., and the mechanical ripple is relatively low. The air conditioner of the configuration 112 is different from that of the configuration 111 in that the air conditioner of the configuration 112 operates in the operation mode 9 for the intermediate load range.

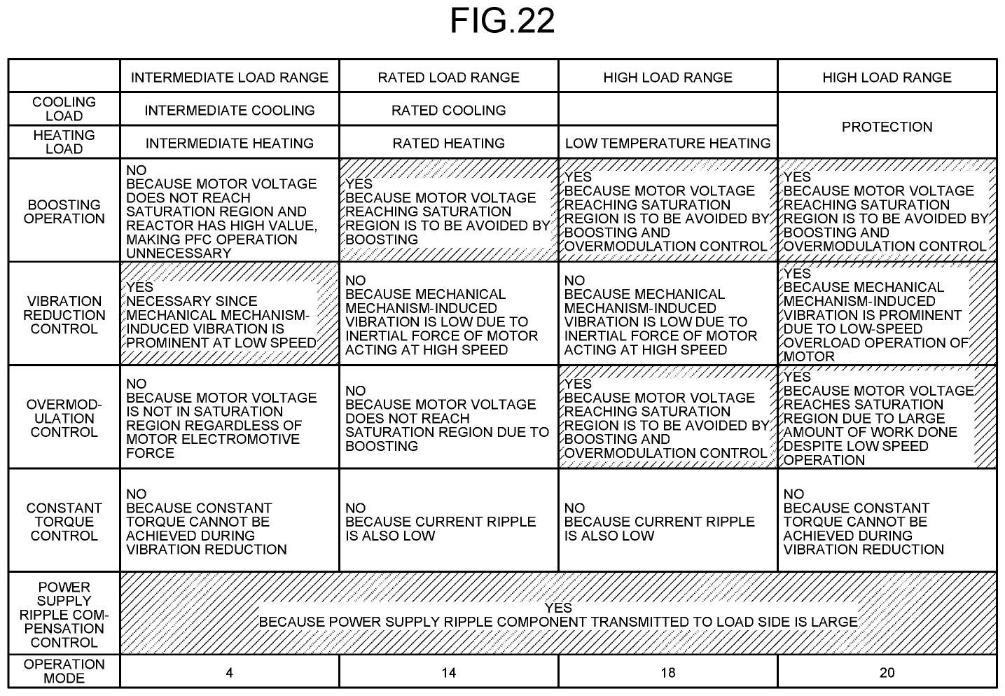

FIG. 22 is a table illustrating the relationships between the air-conditioning conditions and the operation modes in a case where the air conditioner equipped with the power converter 1 according to the first embodiment has a configuration 113. In the configuration 113, the capacitance of the capacitor 210 is reduced as compared to the configuration 109. The air conditioner of the configuration 113 is different from that of the configuration 109 in respect of the presence or absence of the power supply ripple compensation control. As a result, while the air conditioner of the configuration 109 operates in the operation mode 3, the operation mode 13, the operation mode 17, and the operation mode 19, the air conditioner of the configuration 113 operates in the operation mode 4, the operation mode 14, the operation mode 18, and the operation mode 20, respectively.

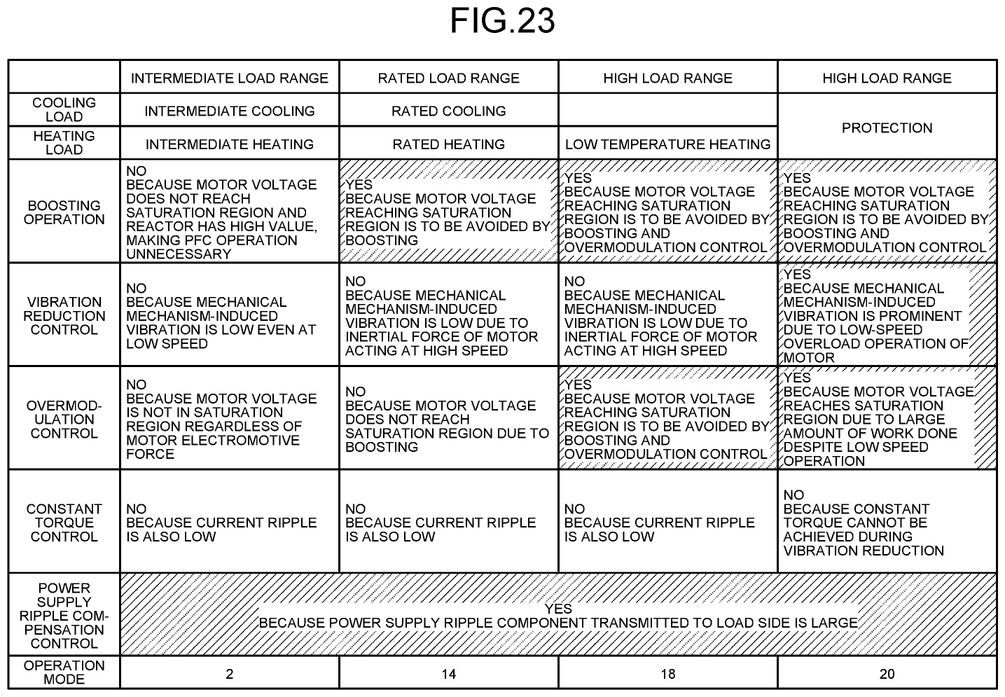

FIG. 23 is a table illustrating the relationships between the air-conditioning conditions and the operation modes in a case where the air conditioner equipped with the power converter 1 according to the first embodiment has a configuration 114. In the configuration 114, as compared to the configuration 113, the mechanical mechanism of the compressor 315 is the twin rotary type, the scroll type, etc., and the mechanical ripple is relatively low. The air conditioner of the configuration 114 is different from that of the configuration 113 in that the air conditioner of the configuration 114 operates in the operation mode 2 for the intermediate load range.

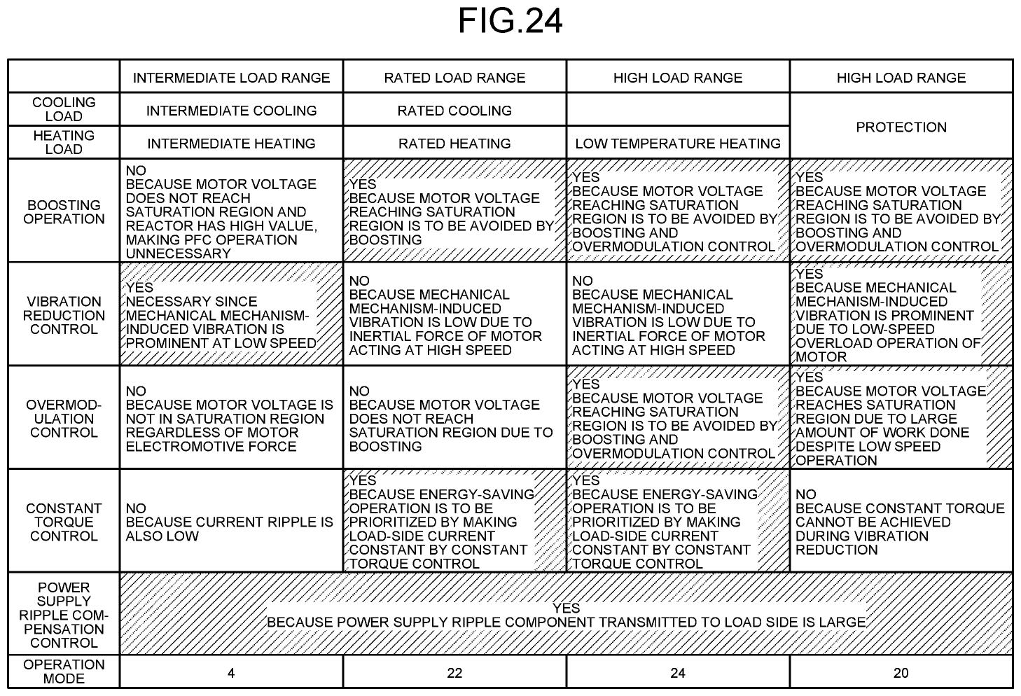

FIG. 24 is a table illustrating the relationships between the air-conditioning conditions and the operation modes in a case where the air conditioner equipped with the power converter 1 according to the first embodiment has a configuration 115. In the configuration 115, as compared to the configuration 113, the motor electromotive force is improved, that is, reduced by, for example, increasing the number of turns in the motor 314. The air conditioner of the configuration 115 is different from that of the configuration 113 in that the air conditioner of the configuration 115 operates in the operation mode 22 for the rated load range and operates in the operation mode 24 for the low temperature heating.

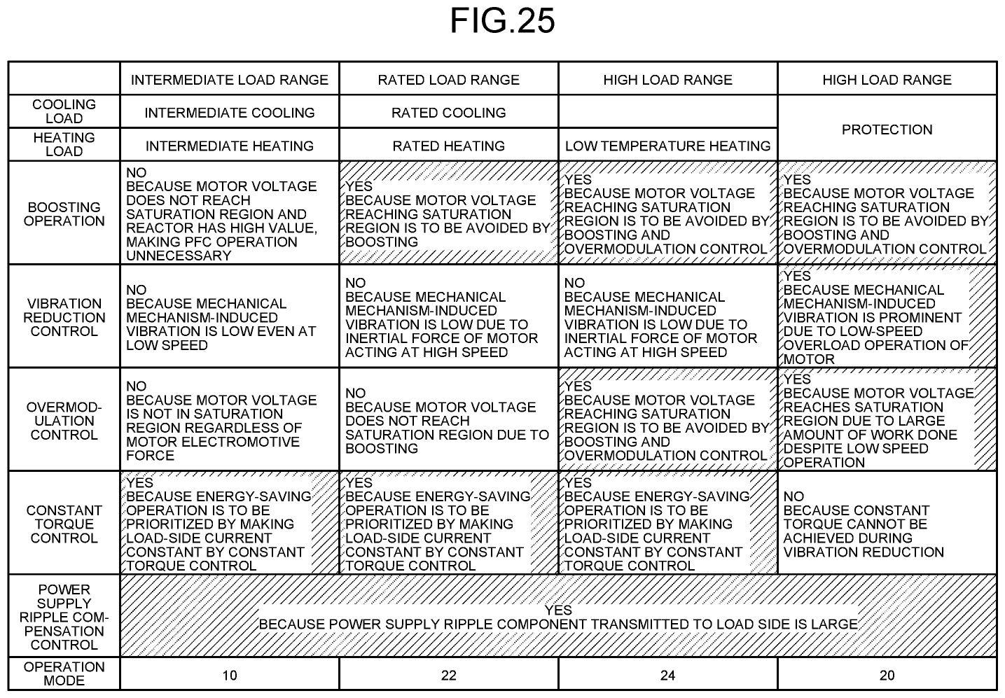

FIG. 25 is a table illustrating the relationships between the air-conditioning conditions and the operation modes in a case where the air conditioner equipped with the power converter 1 according to the first embodiment has a configuration 116. In the configuration 116, as compared to the configuration 115, the mechanical mechanism of the compressor 315 is the twin rotary type, the scroll type, etc., and the mechanical ripple is relatively low. The air conditioner of the configuration 116 is different from that of the configuration 115 in that the air conditioner of the configuration 116 operates in the operation mode 10 for the intermediate load range.

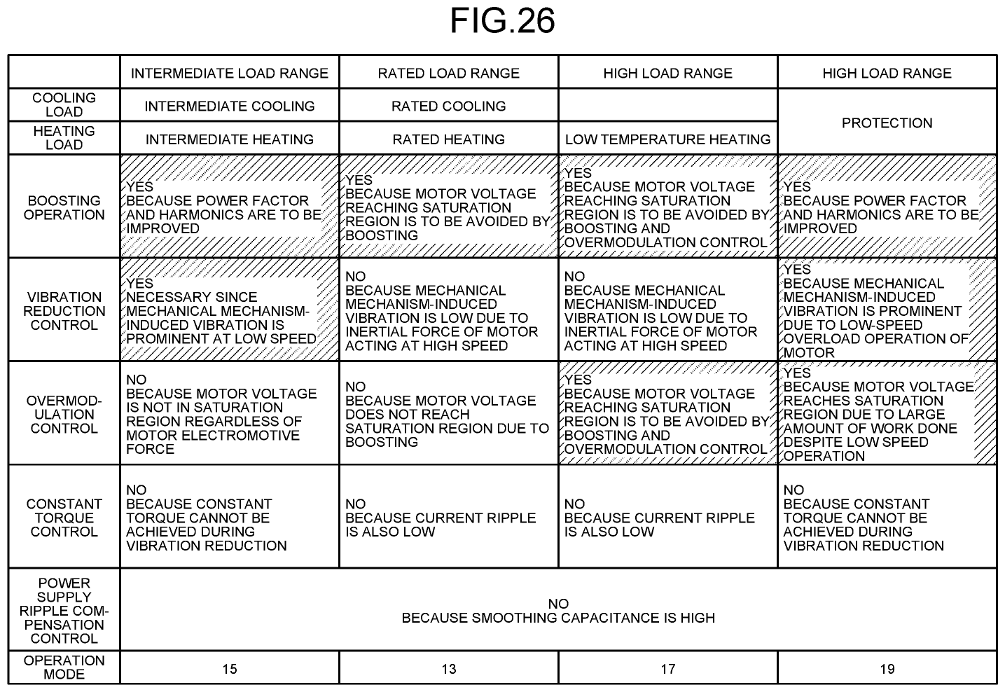

FIG. 26 is a table illustrating the relationships between the air-conditioning conditions and the operation modes in a case where the air conditioner equipped with the power converter 1 according to the first embodiment has a configuration 117. In the configuration 117, as compared to the configuration 101, the converter is changed from the passive configuration to the full SW system. The air conditioner of the configuration 117 is different from that of the configuration 101 in respect of the presence or absence of the boosting operation. As a result, while the air conditioner of the configuration 101 operates in the operation mode 1, the operation mode 3, the operation mode 5, and the operation mode 7, the air conditioner of the configuration 117 operates in the operation mode 13, the operation mode 15, the operation mode 17, and the operation mode 19, respectively.

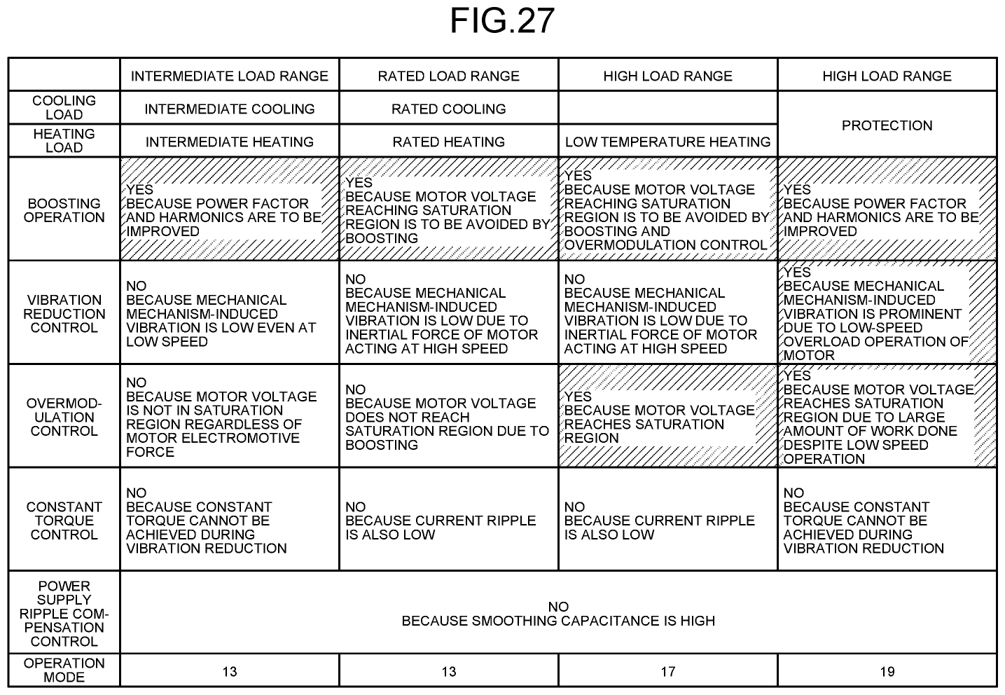

FIG. 27 is a table illustrating the relationships between the air-conditioning conditions and the operation modes in a case where the air conditioner equipped with the power converter 1 according to the first embodiment has a configuration 118. In the configuration 118, as compared to the configuration 117, the mechanical mechanism of the compressor 315 is the twin rotary type, the scroll type, etc., and the mechanical ripple is relatively low. The air conditioner of the configuration 118 is different from that of the configuration 117 in that the air conditioner of the configuration 118 operates in the operation mode 13 for the intermediate load range.

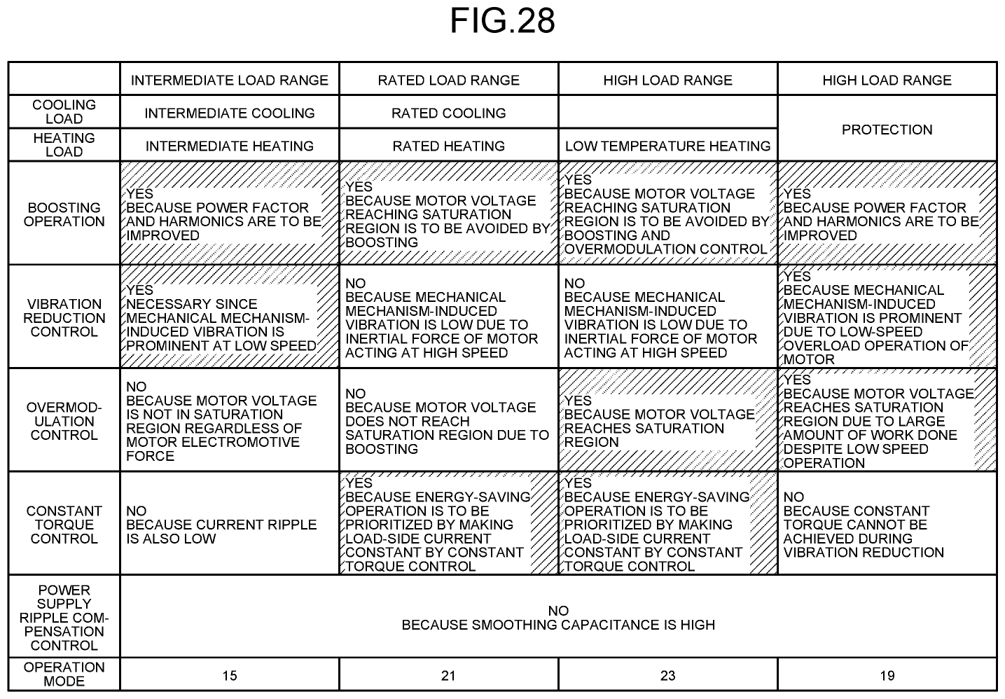

FIG. 28 is a table illustrating the relationships between the air-conditioning conditions and the operation modes in a case where the air conditioner equipped with the power converter 1 according to the first embodiment has a configuration 119. In the configuration 119, as compared to the configuration 117, the motor electromotive force is improved, that is, reduced by, for example, increasing the number of turns in the motor 314. The air conditioner of the configuration 119 is different from that of the configuration 117 in that the air conditioner of the configuration 119 operates in the operation mode 21 for the rated load range and operates in the operation mode 23 for the low temperature heating.

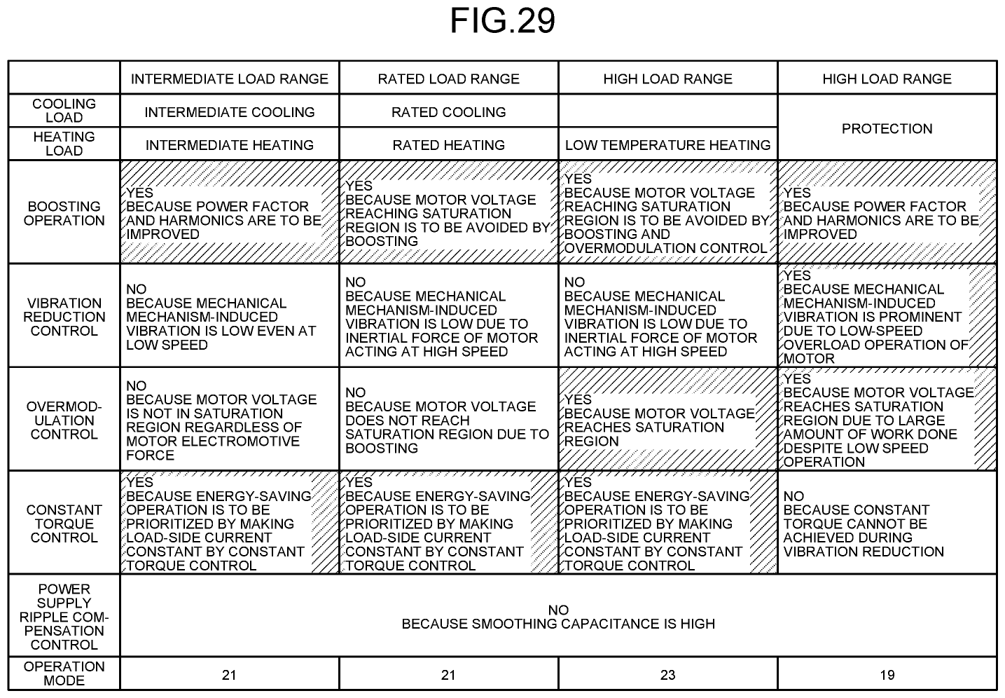

FIG. 29 is a table illustrating the relationships between the air-conditioning conditions and the operation modes in a case where the air conditioner equipped with the power converter 1 according to the first embodiment has a configuration 120. In the configuration 120, as compared to the configuration 119, the mechanical mechanism of the compressor 315 is the twin rotary type, the scroll type, etc., and the mechanical ripple is relatively low. The air conditioner of the configuration 120 is different from that of the configuration 119 in that the air conditioner of the configuration 120 operates in the operation mode 21 for the intermediate load range.

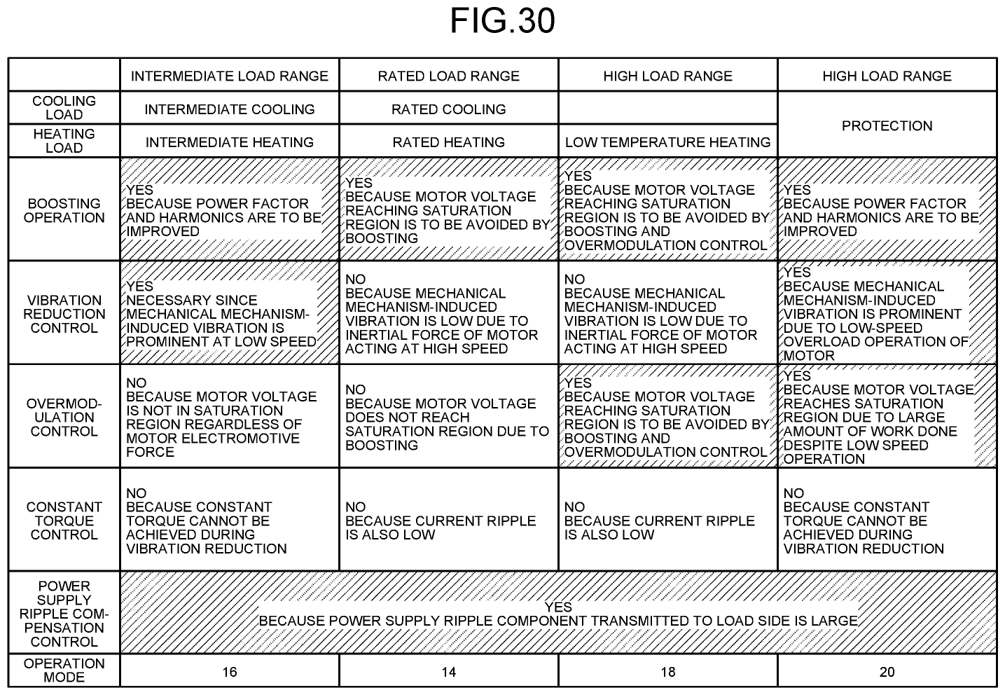

FIG. 30 is a table illustrating the relationships between the air-conditioning conditions and the operation modes in a case where the air conditioner equipped with the power converter 1 according to the first embodiment has a configuration 121. In the configuration 121, the capacitance of the capacitor 210 is reduced as compared to the configuration 117. The air conditioner of the configuration 121 is different from that of the configuration 117 in respect of the presence or absence of the power supply ripple compensation control. As a result, while the air conditioner of the configuration 117 operates in the operation mode 13, the operation mode 15, the operation mode 17, and the operation mode 19, the air conditioner of the configuration 121 operates in the operation mode 14, the operation mode 16, the operation mode 18, and the operation mode 20, respectively.

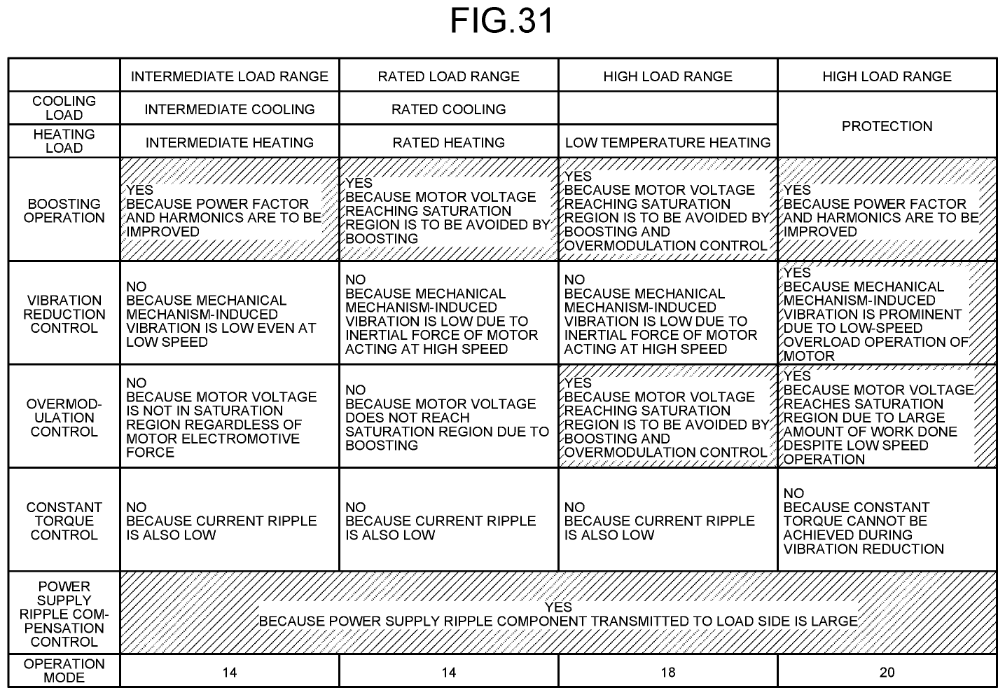

FIG. 31 is a table illustrating the relationships between the air-conditioning conditions and the operation modes in a case where the air conditioner equipped with the power converter 1 according to the first embodiment has a configuration 122. In the configuration 122, as compared to the configuration 121, the mechanical mechanism of the compressor 315 is the twin rotary type, the scroll type, etc., and the mechanical ripple is relatively low. The air conditioner of the configuration 122 is different from that of the configuration 121 in that the air conditioner of the configuration 122 operates in the operation mode 14 for the intermediate load range.

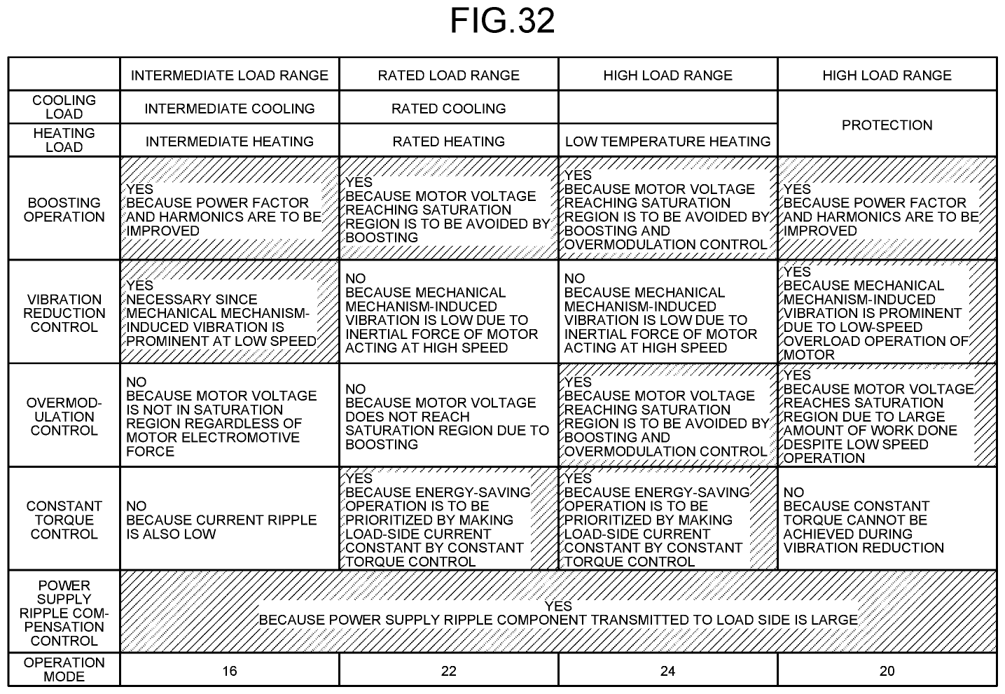

FIG. 32 is a table illustrating the relationships between the air-conditioning conditions and the operation modes in a case where the air conditioner equipped with the power converter 1 according to the first embodiment has a configuration 123. In the configuration 123, as compared to the configuration 121, the motor electromotive force is improved, that is, reduced by, for example, increasing the number of turns in the motor 314. The air conditioner of the configuration 123 is different from that of the configuration 121 in that the air conditioner of the configuration 123 operates in the operation mode 22 for the rated load range and operates in the operation mode 24 for the low temperature heating.

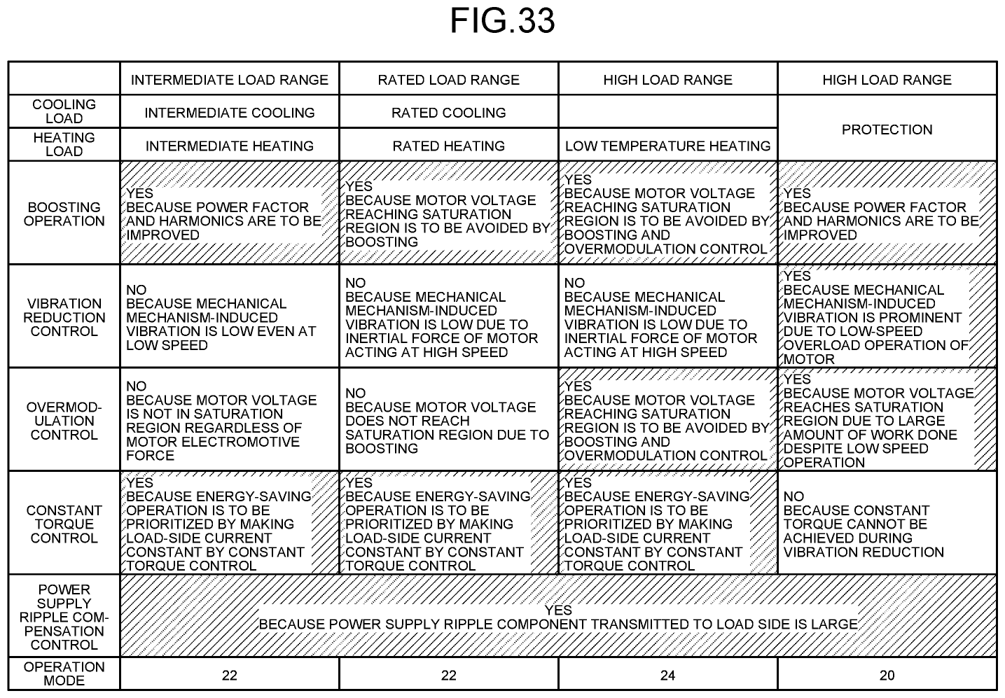

FIG. 33 is a table illustrating the relationships between the air-conditioning conditions and the operation modes in a case where the air conditioner equipped with the power converter 1 according to the first embodiment has a configuration 124. In the configuration 124, as compared to the configuration 123, the mechanical mechanism of the compressor 315 is the twin rotary type, the scroll type, etc., and the mechanical ripple is relatively low. The air conditioner of the configuration 124 is different from that of the configuration 123 in that the air conditioner of the configuration 124 operates in the operation mode 22 for the intermediate load range.

For the air conditioner of the configurations 101 to 124, the control unit 400 can determine the presence or absence of the power supply ripple compensation control, depending on the capacitance of the capacitor 210, for example. The control unit 400 can also determine the presence or absence of the vibration reduction control, depending on the mechanism of the compressor 315 that is the device. Furthermore, the control unit 400 can determine the presence or absence of the operation of the rectifying and boosting unit 700 and each control, depending on the electromotive force of the motor 314.

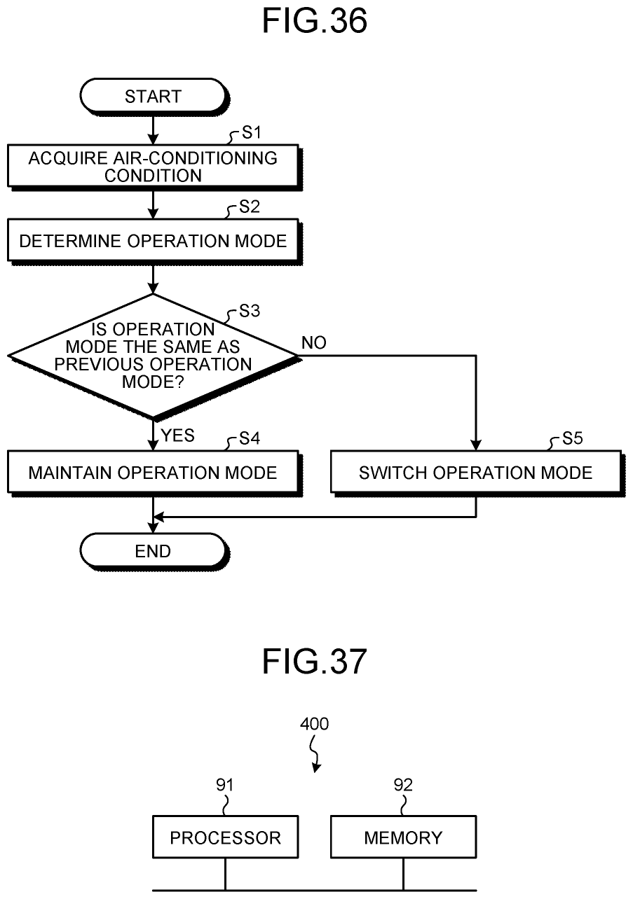

The operation of the control unit 400 will be described with reference to a flowchart. FIG. 36 is a flowchart illustrating the operation of the control unit 400 of the power converter 1 according to the first embodiment. The control unit 400 acquires the air-conditioning condition of the power converter 1 (step S1). The control unit 400 determines the presence or absence of each control from the air-conditioning condition acquired, and determines the operation mode corresponding to the air-conditioning condition (step S2). The control unit 400 checks whether or not the operation mode determined is the same as the previous operation mode (step S3). If the operation mode is the same as the previous operation mode (Yes in step S3), the control unit 400 maintains the previous operation mode (step S4). If the operation mode is different from the previous operation mode (No in step S3), the control unit 400 switches the operation mode (step S5).

Next, a hardware configuration of the control unit 400 included in the power converter 1 will be described. FIG. 37 is a diagram illustrating an example of the hardware configuration that implements the control unit 400 included in the power converter 1 according to the first embodiment. The control unit 400 is implemented by a processor 91 and a memory 92.

The processor 91 is a central processing unit (CPU) or a system large scale integration (LSI), the CPU being also referred to as a central processor, a processing unit, an arithmetic unit, a microprocessor, a microcomputer, a processor, or a digital signal processor (DSP). The memory 92 is, for example, a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)). The memory 92 is not limited thereto, and may be a magnetic disk, an optical disc, a compact disc, a mini disc, or a digital versatile disc (DVD).

As described above, according to the present embodiment, the control unit 400 of the power converter 1 controls the operation of the inverter 310 on the basis of the detected value acquired from each detection unit, and superimposes, on the current I2 flowing through the inverter 310, the ripple of the frequency component dependent on the frequency component of the current I1 flowing from the rectifying unit 130, thereby reducing the current I3 flowing through the smoothing unit 200. With the reduction in the current I3 flowing through the smoothing unit 200, therefore, the power converter 1 can use the capacitor 210 having a low ripple current tolerance, as compared to a power converter not performing the control of the present embodiment. In addition, with the reduction in the ripple voltage of the capacitor voltage Vdc, the power converter 1 can reduce the capacitance of the capacitor 210 installed, as compared to a power converter not performing the control of the present embodiment. In a case where the smoothing unit 200 includes a plurality of the capacitors 210, for example, the power converter 1 can reduce the number of the capacitors 210 of the smoothing unit 200.

Moreover, the power converter 1 controls the operation of the inverter 310 such that the ripple contained in the second alternating-current power is lower than the ripple of the power output from the rectifying unit 130. This prevents an excessive ripple component superimposed on the current I2 flowing through the inverter 310. While the superimposition of the ripple component increases an effective value of current flowing through the inverter 310, the motor 314, etc. as compared with the effective value in a non-superimposed state, it is possible to provide a system that reduces the current capacity of the inverter 310, an increase in loss of the inverter 310, an increase in loss of the motor 314, etc. because of the prevention of the excessive superimposed ripple component.

In addition, by performing the control of the present embodiment, the power converter 1 can reduce the vibration of the compressor 315 generated due to the ripple of the current I2.

Moreover, the boosting unit 600 of the power converter 1 performs the boosting operation, thereby increasing the capacitor voltage Vdc of the capacitor 210 and expanding the range of voltage that can be output from the inverter 310. In the power converter 1, the control unit 400 superimposes, on a drive signal for the switching element 632 of the boosting unit 600, the frequency component of the ripple contained in the second alternating-current power output from the inverter 310, thereby reducing the current I3 and the ripple of the capacitor voltage Vdc due to the frequency component.

In addition, the power converter 1 switches the operation mode in accordance with the air-conditioning condition. As a result, the power converter 1 can perform the energy-saving operation when possible without unnecessarily increasing the processing load.

### Second Embodiment

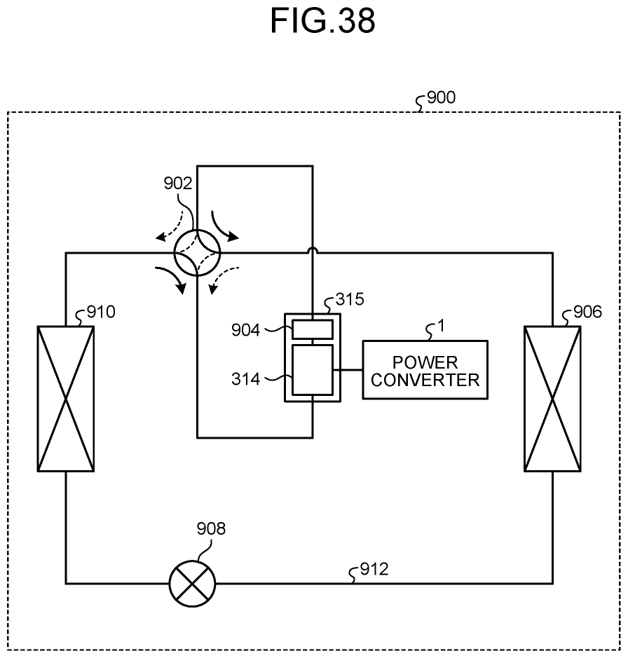

FIG. 38 is a diagram illustrating an example of a configuration of a refrigeration cycle applied apparatus 900 according to a second embodiment. The refrigeration cycle applied apparatus 900 according to the second embodiment includes the power converter 1 described in the first embodiment. The refrigeration cycle applied apparatus 900 according to the second embodiment can be applied to a product including a refrigeration cycle, such as an air conditioner, a refrigerator, a freezer, or a heat pump water heater. The present embodiment makes an assumption similar to that of the first embodiment described above, specifically, an assumption that the air conditioner is the refrigeration cycle applied apparatus 900. Note that in FIG. 38, a component having a function similar to that of the first embodiment is assigned a reference numeral identical to that assigned to the component in the first embodiment.

In the refrigeration cycle applied apparatus 900, the compressor 315 incorporating the motor 314 of the first embodiment, a four-way valve 902, an indoor heat exchanger 906, an expansion valve 908, and an outdoor heat exchanger 910 are installed via refrigerant piping 912.

A compression mechanism 904 that compresses a refrigerant and the motor 314 that causes the compression mechanism 904 to operate are provided inside the compressor 315.

The refrigeration cycle applied apparatus 900 can perform heating operation or cooling operation by a switching operation of the four-way valve 902. The compression mechanism 904 is driven by the motor 314 that is variable-speed controlled.

At the time of the heating operation, as indicated by solid arrows, the refrigerant is pressurized and delivered by the compression mechanism 904, passes through the four-way valve 902, the indoor heat exchanger 906, the expansion valve 908, the outdoor heat exchanger 910, and the four-way valve 902, and returns to the compression mechanism 904.

At the time of the cooling operation, as indicated by broken arrows, the refrigerant is pressurized and delivered by the compression mechanism 904, passes through the four-way valve 902, the outdoor heat exchanger 910, the expansion valve 908, the indoor heat exchanger 906, and the four-way valve 902, and returns to the compression mechanism 904.

At the time of the heating operation, the indoor heat exchanger 906 acts as a condenser to release heat, and the outdoor heat exchanger 910 acts as an evaporator to absorb heat. At the time of the cooling operation, the outdoor heat exchanger 910 acts as a condenser to release heat, and the indoor heat exchanger 906 acts as an evaporator to absorb heat. The expansion valve 908 decompresses and expands the refrigerant.

The configurations illustrated in the above embodiments merely illustrate an example so that another known technique can be combined, the embodiments can be combined together, or the configurations can be partially omitted and/or modified without departing from the scope of the present disclosure.

### REFERENCE SIGNS LIST

1 power converter; 2 motor driving apparatus; 110 commercial power supply; 120, 631 reactor; 130 rectifying unit; 131 to 134, 621 to 624 rectifier element; 200 smoothing unit; 210 capacitor; 310 inverter; 311a to 311f, 611 to 614, 632 switching element; 312a to 312f freewheeling diode; 313a, 313b, 501, 502 current detection unit; 314 motor; 315 compressor; 400 control unit; 600, 601 boosting unit; 633 diode; 700, 701, 702 rectifying and boosting unit; 900 refrigeration cycle applied apparatus; 902 four-way valve; 904 compression mechanism; 906 indoor heat exchanger; 908 expansion valve; 910 outdoor heat exchanger; 912 refrigerant piping.

1. A power converter to be installed in an air conditioner, the power converter comprising:
a rectifier and booster to rectify first alternating-current power supplied from a commercial power supply and boost a voltage of the first alternating-current power;
a capacitor connected to an output end of the rectifier and booster;
an inverter connected across the capacitor, to convert power output from the rectifier and booster and the capacitor, into second alternating-current power, and output the second alternating-current power to a device equipped with a motor; and
a controller to reduce a current flowing through the capacitor by controlling an operation of the rectifier and booster and by controlling an operation of the inverter such that the inverter outputs, to the device, the second alternating-current power containing a ripple dependent on a ripple of power flowing from the rectifier and booster into the capacitor, wherein
the controller controls operation of the power converter in accordance with an air-conditioning condition of the air conditioner, and
the operation of the power converter is determined by presence or absence of: an operation of the rectifier and booster; vibration reduction control that reduces vibration of the motor or the device; overmodulation control of the inverter; constant torque control on the motor; and power supply ripple compensation control that reduces a charge/discharge current through the capacitor.

2. (canceled)

3. The power converter according to claim 1, wherein
the operation of the power converter includes flux weakening control.

4. The power converter according to claim 1, wherein
the controller determines the presence or absence of the power supply ripple compensation control, depending on capacitance of the capacitor.

5. The power converter according to claim 1, wherein
the controller determines the presence or absence of the vibration reduction control, depending on a mechanism of the device.

6. The power converter according to claim 1, wherein
the controller determines the presence or absence of the operation of the rectifier and booster and each of the controls, depending on electromotive force of the motor.

7. The power converter according to claim 1, wherein
the air-conditioning condition includes at least one of intermediate cooling, rated cooling, intermediate heating, rated heating, and low temperature heating.

8. The power converter according to claim 1,
wherein
the air-conditioning condition is acquired from at least one of a user's setting on the air conditioner, a temperature of the outside where an outdoor unit of the air conditioner is installed, a temperature in a room where an indoor unit of the air conditioner is installed, and an operating time of the air conditioner.

9. A motor driving apparatus comprising the power converter according to claim 1.

10. An air conditioner comprising the power converter according to claim 1.
